(19) United States
(12) Patent Application Publication
(10) Pub. No.: US 2021/0110361 A1
(43) Pub. Date: Apr. 15, 2021

(54) BOOKMAKER MANAGEMENT APPARATUS

(71) Applicant: Universal Entertainment Corporation, Tokyo (JP)

(72) Inventor: Nobuyuki NONAKA, Tokyo (JP)

(21) Appl. No.: 17/129,276

(22) Filed: Dec. 21, 2020

Related U.S. Application Data
(63) Continuation of application No. 13/384,118, filed on Feb. 8, 2012, now abandoned.

(30) Foreign Application Priority Data
Jul. 14, 2009 (JP) 2009165800

(51) Int. Cl. G06Q 20/10; G07F 19/00; G06Q 20/20; G06Q 20/28; G06Q 20/34; G06Q 20/12; G07F 17/32; G06Q 20/36; G06Q 20/06

(52) U.S. Cl. CPC G06Q 20/10; G07F 19/20; G06Q 20/20; G06Q 20/108; G06Q 20/065; G06Q 20/341; G06Q 20/12; G07F 17/3288; G06Q 20/36; G06Q 20/28

(57) ABSTRACT

The present invention manages money received from a general user having no bank account, so that the general user is able to make payment, send remittance, receive lottery prize via a network. A deposit amount managing device of the present invention includes a deposit amount storage unit which stores a deposit amount of each of a plurality of users, a deposit amount managing unit which increases or decreases the deposit amount of any of the users in response to a request from a user terminal device, a store terminal device, or an automatic teller machine, and a cash processing unit which generates a account transfer requesting message and transmit the message to a financial institution system to cause the system to receive or disburse cash in order to convert cash to deposit or deposit to cash.

### CROSS REFERENCE RELATED APPLICATION

This application is a continuation of U.S. patent application Ser. No. 13/384,118 filed on Jan. 13, 2012, which application is the national stage of PCT/JP2009/069450, filed Nov. 16, 2009, which application claims priority to Japanese Pat. App. No. 2009-165800, filed Jul. 14, 2009, each of which applications are incorporated herein by reference in their entireties.

### TECHNICAL FIELD

The present invention relates to a deposit amount managing device, a service providing system having the deposit amount managing device, and a deposit amount managing system having a portable terminal. More specifically, the present invention relates to: a deposit amount managing device capable of managing money received from a general user who has no bank account so as to allow even the general users to do payment, send remittance, and receive lottery prize money via a network; a service providing system having such a deposit amount managing device; and a deposit amount managing system having a portable terminal.

### BACKGROUND ART

Advancement and prevalence of communication technology and communication devices enabled communication and data transport by using portable phones and PCs (personal computers) among various countries including advanced countries and developing countries. Through the communication are made various commercial transactions, and money payments and receptions associated with the transactions.

Typical commercial transactions using a network technology premise that the general users and a business to become a trading partner have their own bank accounts. This is because, when a commercial transaction is made through the network and a deal is done, money payments and receptions are processed in the form of money transfer between bank accounts (see Patent Citations 1 to 4). For example, Patent Citation 2 discloses a method of sending remittance, in which money is transferred by using portable phones, between accounts regarded as virtual branches of actually-existing banks. Further, Patent Citation 3 discloses a monetary service device capable of depositing cash into a bank account set by a subscriber, through a mobile communication network of the next generation.

### PRIOR ART DOCUMENT

### Patent Citation

Patent Citation 1: Japanese Unexamined Patent Publication No. 67570/2003 (Tokukai 2003-67570) (see paragraphs [0002]-[0011])

Patent Citation 2: Japanese Unexamined Patent Publication No. 357214/2001 (Tokukai 2001-357214)

Patent Citation 3: Japanese Unexamined Patent Publication No. 56186/2002 (Tokukai 2002-56186)

Patent Citation 4: Japanese Unexamined Patent Publication No. 30449/2003 (Tokukai 2003-30449)

### Means to Solve the Problem

### Technical Problem

Thus, when a general user wishes to make a transaction (purchase, remittance, deposit) by using a network, that general user needs to own a bank account or a credit card associated with the bank account. However, opening a bank account requires procedures involving various documents. This should not be so much of a concern if it is in an urban area where financial institutions are concentrated. In rural areas such as a suburbs and mountainous regions however, the number of facilities of the financial institutions is limited and therefore opening a new account is not easy. Even after an account is opened at a financial institution, it is not unusual that the account holder is required to deposit at least a certain amount of money in the account to maintain the account. Otherwise, the account holder is required to pay a fee as an account maintenance fee or the like. For this reason, maintenance of an account could be a burden for general users with limited incomes. This inconvenience is particularly a severe concern in developing countries whose economies are in the process of developing. Further, due to the delay in the development of so-called broad band environment such as optical fibers and ADSL in these countries, the percentage of households having a PC (personal computer) at their home is still low. For this reason, even if the infrastructure is developed for a ubiquitous network that allows anybody to make commercial transactions anytime, it still may be difficult to promote such transactions using a network. Generally in these developing countries, a network is accessed by using portable phones. Access by using a PC (personal computer) is significantly rare. Owing to the shortages in the bases of banking services and the network banking environments using PCs (personal computers), there are many problems. For example, when a migrant worker wants to remit money outside the country, the remittance may be made through an illegal remittance measure which charges the worker a high service fees and causes difficulties in tracing the money transfer by the government. Further, such an illegal remittance measure may be used for so-called money laundering. Under these circumstances, there has been a demand for a system that enables citizens in general to easily make transactions at anytime, at low costs, under control of the government.

It is therefore an object of the present invention to provide: a deposit amount managing device capable of managing money received from a general user having no bank account so as to allow the general user to easily make payment, send remittance, receive prize money of a lottery, a sportsbook, or the like through a network at low costs by using a portable phone or the like; a service providing system having the deposit amount managing device; and a deposit amount managing system having a portable terminal.

### Technical Solution

To solve the above described problems, the present invention has the following characteristics. Namely, the present invention is suggested as a deposit amount managing device. The deposit amount managing device includes: storage means (e.g., deposit amount storage unit) for storing a deposit amount of each of a plurality of users; deposit amount managing means (e.g., deposit amount managing unit) for increasing or decreasing the deposit amount of any of the users, in response to a request from another device; and cash processing means (e.g., cash processing unit) for generating an account transfer requesting message when converting a value into the deposit amount or converting the deposit amount into a value, and transmitting the account transfer requesting message to a financial institution system to cause the financial institution system to execute a cash balancing process (aspect (1)).

The present invention (the aspect (1)) allows management of money received from a general user so as to allow the user to make payment, send remittance, receive a lottery prize, or the like through a network, even if the user has no bank account.

The “value” means a value which is paid as a counter value for purchasing a service or product. Such a value is for example, cash, a balance (remaining amount) stored in a pre-paid card, electronic money, service points (a value given to a purchaser as a reward when selling a product), or the like.

The above structure (the aspect (1)) may be adapted so that the storage means has for each of the users one individual user deposit amount storage unit, and the individual user deposit amount storage unit includes a plurality of separate storages. This structure (the aspect (2)) enables management and use, as if the cash is separately stored in different wallets or pockets.

Further, the above structure (the aspect (1) or (2)) may be adapted so that a currency in which money is stored is set for each of the separate storages. This structure (the aspect (3)) enables management of a deposit amount in a currency the user wishes.

The above structure (any one of the aspects (1) to (3)) may be adapted so that the deposit amount managing device has a money exchange means (e.g., money exchange processing unit) for converting one currency into another currency based on an exchange rate obtained from outside, when the currency type differs at a time of increasing/decreasing or transferring the deposit amount. The structure (the aspect (4)) enables depositing of money in a plurality of different currencies. Further, when a predetermined currency is needed, it is possible to disburse money in the currency requested.

Further, the present invention provides the following. (5) The deposit amount managing device of any of the aspects (1) to (4), adapted so that:

the deposit amount managing means subtracts from the deposit amount stored in the storage means a payment amount corresponding to a counter value for a service provided by the service providing server, in response to a request from the portable terminal or the service providing server; and the cash processing means causes the financial institution system to deposit an amount corresponding to the payment amount in an account designated by the account transfer requesting message.

The aspect (5) enables management of money received from a general user so as to allow the user to make a payment of money (e.g., money for goods purchased or money bet on a sportsbook, or the like) through a network, even if the user has no bank account. Note the term service in (5) encompasses a product.

Further, the present invention provides the following. (6) A service providing system including a deposit amount managing device and a bookmaker managing server, wherein: the bookmaker managing server includes selection information receiving means for receiving selection information indicative of a bet target selected in a portable terminal, result information receiving means for receiving result information indicative of a result of a competition involving a plurality of competitors, and prize money information transmitting means for transmitting prize money information indicative of an amount of money won, based on the bet target indicated by the selection information received from the selection information receiving means, and the result of competition indicated by the result information received from the result information receiving means; and the deposit amount managing device has storage means for storing a deposit amount of each of a plurality of users, and deposit amount managing means for increasing or decreasing a deposit amount out of the deposit amounts stored in the storage means, which corresponds to the user indicated by the user identification information of the portable terminal, based on a bet amount corresponding to the counter value for betting and/or the amount of money won indicated by the prize money information transmitted by the prize money information transmitting means.

The aspect (6) enables a user having no bank account to participate in betting (e.g., sportsbook) provided by a bookmaker, by using a portable terminal (e.g., portable phones or a Personal Handyphone System (PHS)).

Further, the present invention provides the following. (7) The service providing system of the aspect (6), adapted so that

the service providing system has a portable terminal capable of communicating with the bookmaker managing server,

the portable terminal has a digital broadcast receiving means for receiving digital broadcast, selection means for enabling selection of a bet target related to the digital broadcast received from the digital broadcast receiving means, and selection information transmitting means for transmitting, to the bookmaker managing server, selection information indicative of the bet target selected by using the selection means, along with the user identification information in the portable terminal.

The aspect (7) enables the user to view digital broadcast received by the portable terminal and enjoy the process (e.g., soccer game, horse race) in which the result of betting (e.g., sportsbook) provided by a bookmaker is determined. Further, while viewing the digital broadcast (e.g., during a soccer game or before the start of a soccer game), the user is easily able to participate in the betting (e.g., sportsbook) provided by the bookmaker. Note that the selection means in the aspect (7) may be structured to enable selection of a bet target before the digital broadcast is received, or structured to enable selection of a bet target during the reception of the digital broadcast. Needless to say that the selection means may be structured to enable selection of a bet target before and during the reception of the digital broadcast.

Further, the present invention provides the following. (8) A deposit amount managing system, including: a deposit amount managing device and a portable terminal capable of communicating with the deposit amount managing device, wherein

the portable terminal includes terminal storage means for storing a charge value indicative of a value, value information transmitting means for transmitting value information indicative of a value which is equal to or less than the charge value stored in the terminal storage means, charge value subtraction means for subtracting, from the charge value stored in the terminal storage means, the value indicated by the value information transmitted by the value information transmitting means; and

the deposit amount managing device includes storage means for storing a deposit amount, value information reception means for receiving the value information, deposit amount increasing means for increasing the deposit amount stored in the storage means by an amount corresponding to the value indicated by the value information received by the value information reception means.

With the aspect (8), the deposit amount is increased by the amount corresponding to the value subtracted from the charge value in the terminal storage means (e.g., in the memory provided to the IC chip of a portable phones). Accordingly, the user is able to shift the value from the portable terminal to the deposit amount managing device by operating the portable terminal.

The aspect (8) is preferably structured so as to enable payments in everyday life; e.g., payments for purchasing products or payments for using public transportations, by using a charge value (electronic money) stored in the terminal storage means. For example, the following structure may be adopted. The portable terminal has a contactless IC chip provided with a memory serving as the terminal storage means. The contactless IC chip is capable of communicating with an account settling terminal set in a store or the like. The user is able to make payment by holding the portable terminal nearby the account settling terminal. Thus, by depositing in the deposit amount managing device an amount of electronic money that surpasses the amount to be used in everyday life, the user is able to prepare for situations such as robbery.

Realizing such a settlement using a portable terminal is especially effective for areas with poor securities. The amount of money needed for everyday life is likely to be withdrawn from an ATM (Automated Teller Machine). However, in areas with poor securities, there is a concern that cash deposited in ATMs are frequently robbed. For this reason, in these areas, setting of an ATM is hesitated. As a result, it has been difficult to build a network of ATMs. However, by realizing settlement using a portable terminal, payment of money occurring in everyday life is easily done in those areas.

The portable terminal of the aspect (8) may have charge value adding means for adding, to the charge value stored in the terminal storage means, a value corresponding to an amount of money won (e.g., amount of money won in the aspect (6)) in lottery, a sportsbook, or the like, or a value corresponding to the amount of coins earned in a gaming facility such as casino. In this case, the portable terminal has prize money information receiving means for receiving information indicative of an amount of money won, from a server (e.g., bookmaker managing server of the aspect (6)) managing lottery or a sportsbook, or from a gaming machine set in a gaming facility. This way, the value won in the betting or the game can be allotted to the expense for everyday life. Further, by operating a portable terminal, the value can be shifted to the deposit amount managing device. Therefore, the user is able to deposit in the deposit amount managing device an amount which surpasses an amount of money to be used in everyday life, out of a large amount of electronic money earned from betting or the game. This eliminates the concern that a large amount of electronic money is lost when the portable terminal is stolen.

### Effects of the Invention

With the present invention, it is possible to manage money received from a general user so as to allow the user to make payments, send remittance, receive a prize money of a lottery, sportsbook, or the like through a network, even if the user has no bank account.

### BRIEF DESCRIPTION OF DRAWINGS

FIG. 1 is a block diagram showing an exemplary structure of a deposit amount managing system.

FIG. 2 is a function block diagram showing an exemplary structure of a deposit amount managing device.

FIG. 3 is a sequence diagram showing an exemplary operation of the deposit amount managing system at the time of registering a user.

FIG. 4 is a sequence diagram showing an exemplary operation at the time where a user having purchased a pre-paid card is depositing an amount in the deposit amount managing system.

FIG. 5 shows a sequence diagram showing an exemplary operation of the deposit amount managing system at the time of depositing an amount in the deposit amount managing system by using a store terminal device.

FIG. 6 is a sequence diagram showing an exemplary operation of the deposit amount managing system at the time of depositing an amount by using an automatic teller machine.

FIG. 7 is a sequence diagram showing an exemplary operation of the deposit amount managing system at the time of withdrawing cash from the deposit amount in the deposit amount managing system.

FIG. 8 is a sequence diagram showing an exemplary operation of the deposit amount managing system at the time of withdrawing cash from the deposit amount in the deposit amount managing system of an alternative form.

FIG. 9 is a sequence diagram showing an exemplary operation of the deposit amount managing system at the time of sending remittance from the deposit amount in the deposit amount managing system.

FIG. 10 is a sequence diagram showing an exemplary operation of the deposit amount managing system 1 at the time of send remittance to a user having no bank account.

FIG. 11 is a sequence diagram showing an exemplary operation of the deposit amount managing system at the time of making payment from a deposit amount in the deposit amount managing system.

FIG. 12 is a sequence diagram showing an exemplary operation of a deposit amount managing system 1 when the user requests confirmation of deposit balance.

FIG. 13 shows a service providing system related to a second embodiment of the present invention.

FIG. 14 is a block diagram showing an internal structure of an SMS server provided to a sportsbook operation managing center related to the second embodiment of the present invention.

FIG. 15 is a block diagram showing an internal structure of a user terminal device related to the second embodiment of the present invention.

FIG. 16A is a sequence diagram showing an exemplary operation of the service providing system related to the second embodiment of the present invention.

FIG. 16B is a sequence diagram showing an exemplary operation of a service providing system related to the second embodiment of the present invention.

FIG. 17 shows an odds display image displayed on the display unit of the user terminal device related to the second embodiment of the present invention.

FIG. 18 is a block diagram showing an internal structure of a user terminal device related to a third embodiment of the present invention.

FIG. 19A is a sequence diagram showing an exemplary operation of the service providing system related to the third embodiment of the present invention.

FIG. 19B is a sequence diagram showing an exemplary operation of the service providing system related to the third embodiment of the present invention.

FIG. 20A shows an exemplary TV program image related to the third embodiment of the present invention.

FIG. 20B shows an exemplary web page of a bookmaker site related to the third embodiment of the present invention.

FIG. 21 is a block diagram showing an internal structure of a user terminal device related to a fourth embodiment of thee present invention.

FIG. 22A is a sequence diagram showing an exemplary operation of a deposit amount managing system related to a fourth embodiment of the present invention.

FIG. 22B is a sequence diagram showing an exemplary operation of the deposit amount managing system related to a fourth embodiment of the present invention.

FIG. 23 is a sequence diagram showing an exemplary operation of a deposit amount managing system related to a fourth embodiment of the present invention.

FIG. 24 shows an exemplary shifting-completion reporting image related to the fourth embodiment of the present invention.

### EMBODIMENTS

The following describes embodiments of the present invention with reference to attached drawings. The present embodiment is suggested as a deposit amount managing system.

### First Embodiment

### [1. Exemplary Structure]

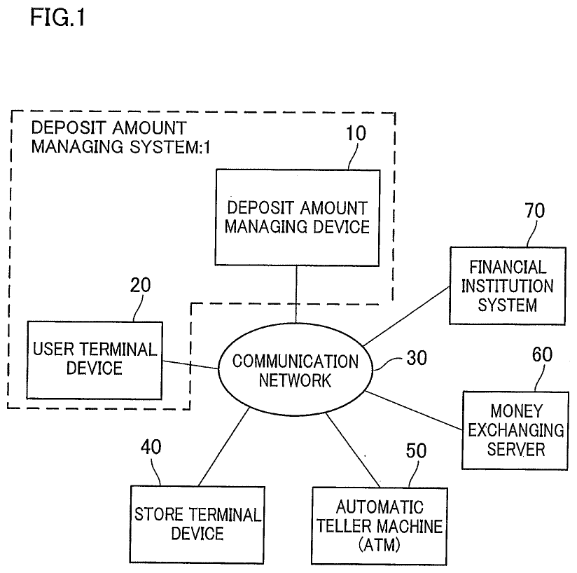

First, the following describes the structure of a deposit amount managing system. FIG. 1 is a block diagram showing an exemplary structure of the deposit amount managing system. The deposit amount managing system 1 has a deposit amount managing device 10 connectable to a communication network 30 and a user terminal device 20 connectable to the communication network 30. The deposit amount managing device 10 is capable of communicating with a store terminal device 40, an automatic teller machine (ATM) 50, a money exchanging server 60, and a financial institution system 70 through a communication network 30.

### [1.1. User Terminal Device]

The user terminal device 20 is an information processing device capable of performing data communication with the deposit amount managing device 10 through a communication network 30. For example, the user terminal device 20 may be a portable phone having a data communication function, a personal computer (PC) or a portable gaming machine having a communication function. The “information processing device” encompasses a device having a calculation process device (CPU), a main memory (RAM), a read-only memory (ROM), an Input/Output device (I/Os), and if necessary an external storage device such as a hard disk device.

The user terminal device 20 may have short-distance communication means (e.g., an IC chip having a contactless IC CARD function) for performing data communication with the store terminal device 40 and/or an automatic teller machine 50, without the communication network 30.

### [1.2. Store Terminal Device]

The store terminal device 40 is a device having a function of requesting the deposit amount managing device 10 to transfer an amount of payment from the deposit amount of the user to the store side, when the user purchases goods or a service at a store (facility and equipment for providing products and services; e.g., retailers such as a convenience store, sports lottery sellers, and restaurants). The store terminal device 40 is an information processing device capable of performing data communication with the deposit amount managing device 10 via a communication network. For example, the store terminal device 40 is a PC having communication function, a cash register, an exclusive use terminal machine.

Note that the store terminal device 40 may have a short-distance communication means (e.g., a reader/writer for reading an IC chip having a contactless IC CARD function) for performing data communication with the user terminal device 20, without the communication network 30.

### [1.3. Automatic Teller Machine]

The automatic teller machine (encompassing automatic cash dispenser in the present specification) 50 is a machine having reception ports and dispensing ports for bills (and coins), bank notes, magnetic cards or the like, and capable of providing services provided by financial institutions, money lenders, and cashing businesses, according to an operation by a client him/her self.

Note that the automatic teller machine 50 may have a short-distance communication means (e.g., a reader/writer for reading an IC chip having a contactless IC CARD function) for performing data communication with the user terminal device 20, without the communication network 30.

### [1.4. Money Exchanging Server]

The money exchanging server 60 has a function of transmitting a money exchange rate to the deposit amount managing device 10. The exchange rate provided by the money exchanging server 60 may be variable realtime, or may be a middle rate which is fixed for a certain period.

### [1.5. Financial Institution System]

The financial institution system (also known as online system) 70 is a system that enables depositing of money or withdrawal of money in/from a designated account, in response to a request from the deposit amount managing device 10.

### [1.6. Deposit Amount Managing Device]

The deposit amount managing device 10 has functions of: recording money deposited by a user; adding an amount of money additionally deposited; subtracting an amount being consumed from the deposit amount; and exchanging a currency (e.g. US dollar) to another currency (e.g., Euro). Further, the deposit amount managing device 10 has a function of transferring deposited money and sending remittance, in response to an instruction given by the user.

The deposit amount managing device 10 is a device realized by an information processing device such as a computer, work station, server, or the like. Such an information processing device is a device having a calculation process device (CPU), a main memory (RAM), a read-only memory (ROM), an Input/Output device (I/O), and if necessary, an external storage device such as hard disk device.

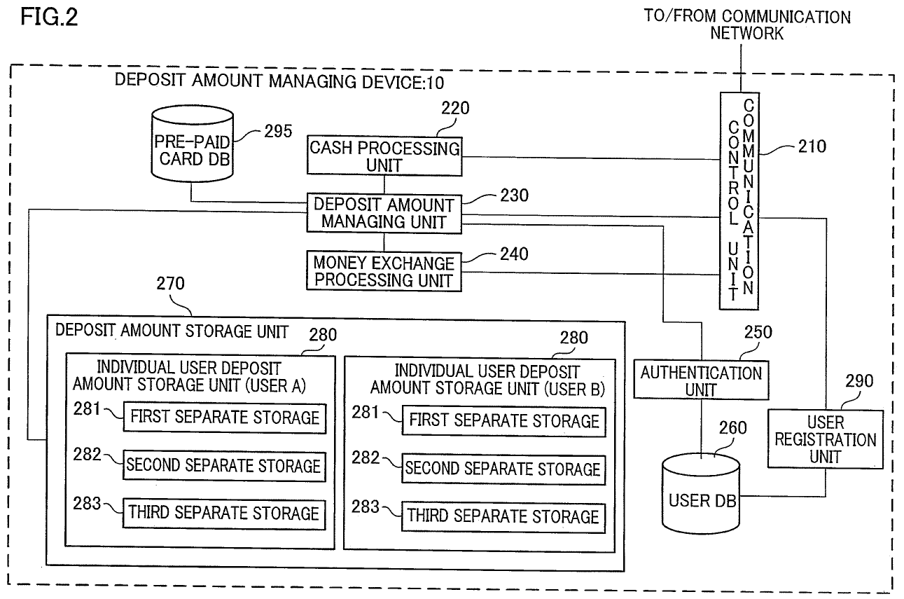

FIG. 2 is a function block diagram showing an exemplary structure of the deposit amount managing device 10. The deposit amount managing device 10 has: a communication control unit 210; a cash processing unit 220, a deposit amount managing unit 230, a money exchange processing unit 240, and a user registration unit 290 which are connected to the communication control unit 210; an authentication unit 250 connected to the deposit amount managing unit 230; a user database (hereinafter, abbreviated to DB) 260 connected to the authentication unit 250; a deposit amount storage unit 270 and a pre-paid card DB 295 which are connected to the deposit amount managing unit 230.

The deposit amount storage unit 270 corresponding to the storage means of the present invention has an individual user deposit amount storage unit 280 for each user. Each individual user deposit amount storage unit 280 has a first separate storage 281, a second separate storage 282, and a third separate storage 283. For the sake of convenience, FIG. 2 shows individual user deposit amount storage units 280 for two users only: user A and user B. This however does not mean that the number of the individual user deposit amount storage units 280 in the deposit amount storage unit 270 is limited to two. The deposit amount storage unit 270 may have the individual user deposit amount storage units 280 in number that corresponding to the number of users. Note that each structuring element corresponds to a function realized by a CPU and a program run by the CPU. The deposit amount managing device 10 does not necessarily have to have actual hardware corresponding to each structuring element.

The following describes the deposit amount managing device 10 and the above mentioned structuring elements.

### [1.6.1. Communication Control Unit]

The communication control unit 210 has a function of executing data transmission/reception via a communication network 30, among the user terminal device 20, the store terminal device 40, the automatic teller machine 50, the money exchanging server 60, and the financial institution system 70. Specifically, the communication control unit 210 executes a predetermined protocol and mutual conversion between data and electric signals.

### [1.6.2. Cash Processing Unit]

The cash processing unit 220 corresponding to the cash processing means of the present invention has a functions of: generating an account transfer requesting message and transmitting the same to the financial institution system 70 to cause the financial institution system 70 to perform a cash balancing process, at the time of converting cash into a deposit amount, and converting the deposit amount into cash. For example, when a user withdraws $100 via the automatic teller machine 50, the deposit amount managing device 10 subtracts $100 from the deposit amount of the user, and the cash processing unit 220 transmits a message requesting the financial institution system 70 handling the bank account of the operator of the deposit amount managing system 1 to withdraw $100 from the bank account of the operator (in the present embodiment, the bank account is one owned by the operator, for the sake of convenience; however, the bank account may be anyone's bank account).

### [1.6.3. Deposit Amount Managing Unit]

The deposit amount managing unit 230 corresponding to the deposit amount managing means of the present invention has a function of increasing or decreasing the deposit amount of the user according to a request message from the user terminal device 20, the store terminal device 40, the automatic teller machine 50, or the like. Specifically, the deposit amount managing unit 230 interprets the request message, and rewrites the contents stored in the deposit amount storage unit 270, based on the interpretation. Further, the deposit amount managing unit 230 also has a function of causing the authentication unit 250 to execute authentication to determine if the request message has legitimate authorization.

### [1.6.4. Money Exchange Processing Unit]

The money exchange processing unit 240 corresponding to the money exchange means of the present invention has functions of requesting the money exchange rate from the money exchanging server 60, when there is a change in the currency type at the time of increasing or decreasing the deposit amount (or transferring the deposit amount); and converting one currency type to another currency type based on the exchange rate transmitted by the money exchanging server 60.

### [1.6.5. Authentication Unit]

When a request message for increasing or decreasing the deposit amount of the user is received from the user terminal device 20, the store terminal device 40, the automatic teller machine 50, or the like, the authentication unit 250 determines if the request message is legitimate based on the data recorded in the user DB 260, and transmits the determination result to the deposit amount managing unit 230. Specifically, for example, the authentication unit 250 checks authentication information transmitted separately or as a part of the request message, against data recorded in the user DB 260. If the information matches, the authentication unit 250 notifies the deposit amount managing unit 230 that increasing or decreasing of the deposit amount according to the request message is permitted. The authentication information may be any type of information. For example, the authentication information may be a combination of a user ID and a password, a portable phone number, or unique information associated with the portable phone.

### [1.6.6. User DB]

The user DB 260 has a function of storing later-mentioned user information, in association with the user and the individual user deposit amount storage unit 280. Further, the user DB 260 has a function of storing the user in association with the authentication information.

### [1.6.7. Deposit Amount Storage Unit]

The deposit amount storage unit 270 has a function of storing the deposit amount for each user. The deposit amount is managed so as to decrease the deposit amount when the user spends an amount from the deposit amount, and increases the deposit amount when the user adds an amount to the deposit amount. In the present embodiment, one individual user deposit amount storage unit 280 is provided for each user. Each individual user deposit amount storage unit 280 has three separate storages: i.e., a first separate storage 281, a second separate storage 282, and a third separate storage 283 which serve as three deposit amount storages independent of one another. (In actual use, the number is not limited to three, and the number of these storages are set according to the needs.) The expression “independent” means that the respective deposit amount stored in any of the separate storages 281 to 283 is not affected by increasing or decreasing of the deposit amount stored in another one of the separate storages 281 to 283, except for a special case (and transferring of a deposit amount from one separate storage to another separate storage). For example, the “special case” is a case where the deposit amount stored in one separate storage is set to be used for covering a shortage in the deposit amount of another separate storage.

In the present embodiment, a currency type (US dollars, Euro, RMB) is set for each of the separate storages 281 to 283. When an amount is added to the deposit amount of any one of the separate storages 281 to 283, that amount is added in the currency type being set, by the deposit amount managing unit 230 and the money exchange processing unit 240. For example, suppose the currency set for the first separate storage 281 is US dollars and the amount deposited therein in advance is US$100. When the user additionally deposits US$10 to the deposit amount, the resulting deposit amount will be US$110. However, when the user additionally deposits JP¥ 2000, this JP¥ 2000 is converted into US dollars based on the USS/JP¥ exchange rate obtained from the money exchanging server 60, and then the resulting amount in US dollars is added. For example, where the USS/JP¥ exchange rate=JP¥ 100/dollar, the deposit amount in the first separate storage 281 after the addition will be: $100+¥2000=$100+$20=$120. (Usually, in currency exchange, there will be a service charge. The amount remaining after subtracting this service charge is given to the user. Description of this service charge is omitted in the above description. However, it goes without saying that the service charge is subtracted from the user's amount in the deposit amount storage unit 280 as the profit for the operator of this system.)

Note that the currencies set to the separate storages 281 to 283 may be all different from one another. Alternatively, the same currency may be set to two or three of the separate storages 281 to 283. Further, the set currency type may be changeable anytime as needed.

### [1.6.8. User Registration Unit 290]

The user registration unit 290 has a function of executing a user registering process, when the user starts to use the deposit amount managing system 1. The user registering process is a process of adding a new record in the user DB 260, and writing the user information in the record.

### [1.6.9. Pre-Paid Card DB]

The pre-paid card DB 295 has functions of storing pre-paid card information, and outputting the pre-paid card information to the deposit amount managing unit 230, in response to an inquiry from the deposit amount managing unit 230. The “pre-paid card” is a card-type securities (store order) having a value corresponding to a certain amount of money which is usable as the deposit amount in the deposit amount managing system 1. The pre-paid card is issued by an operator of the deposit amount managing system 1, an entity entrusted by the operator, or an affiliate of the operator. The pre-paid card has identification information that allows authentication of the pre-paid card, and pre-paid card information containing information indicative of the amount of money or the like. For example, the pre-paid card information is written in the form of printed number or text, or written electrically in a recording medium (e.g., magnetic tape). Thus, the structure of the deposit amount managing system 1 is described.

### [2. Operation of Deposit Amount Managing System]

Next, the following describes an operation of the deposit amount managing system 1.

### [2.1. User Registration]

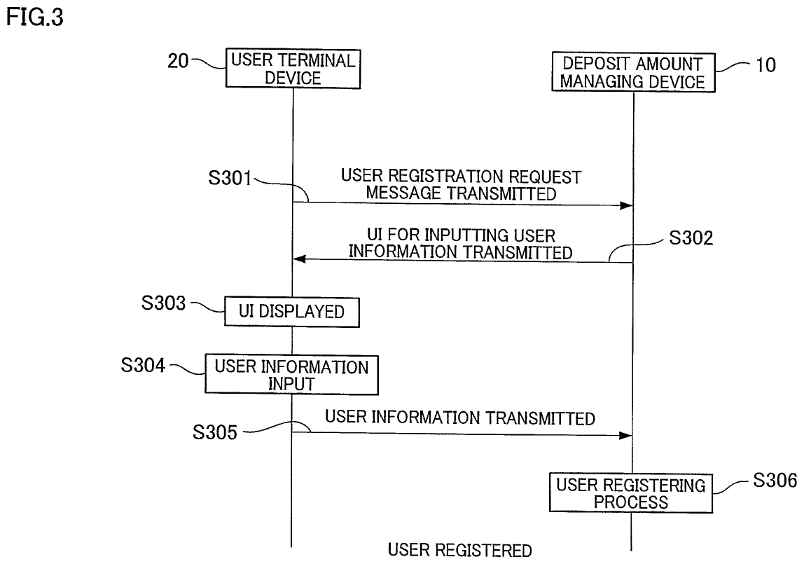

To start using the deposit amount managing system 1, a user first has to register him/herself to the deposit amount managing system 1. FIG. 3 is a sequence diagram showing an exemplary operation of the deposit amount managing system 1 at the time of registering a user. First, the user connects his/her user terminal device 20 to the communication network 30, and transmits a user registration request message to the deposit amount managing device 10 (S301). The deposit amount managing device 10 having received the user registration request message activates the user registration unit 290, and the user registration unit 290 transmits, to the user terminal device 20 via the communication network 30, data to function as the user interface (UI) for inputting user information (S302). The user terminal device 20 having received the data displays the user interface and prompts the user to input user information (S303). The user then inputs user information using the user interface displayed (S304). Note that the “user information” is information related to user which is usable in operation of the system 1. The user information contains information for specifying the user such as a user name, address, or the like. Further, the present invention encompasses a structure in which the user terminal device 20 obtains user information which is not input by the user (e.g., unique information of the portable phone).

Next, the user terminal device 20 transmits user information to the deposit amount managing device 10 via the communication network 30 (S305). The deposit amount managing device 10, when receiving the user information, causes the user registration unit 290 to execute the user registering process (S306). Specifically, a new record is added to the user DB 260, and the user information or the like transmitted in S305 is stored in that record, thus storing the information in the user DB 260. Further, the user registration unit 290 provides a new individual user deposit amount storage unit 280 to the deposit amount storage unit 270. This new individual user deposit amount storage unit 280 is provided with three separate storages 281, 282, and 283 as in the other individual user deposit amount storage units 280. Then, user registration is completed.

### [2.2. Depositing]

Next, the following describes an operation taking place when the user deposits an amount in the deposit amount managing system 1. Depositing is a process of entering a certain amount of money as a deposit money in the deposit amount managing system 1. There are a plurality of ways for depositing money.

### [2.2.1. User Terminal Device and Pre-Paid Card]

The user may purchase a pre-paid card and partly or entirely store the amount of money assigned to the pre-paid card, as a deposit amount, in his/her individual user deposit amount storage unit 280, by sending to the deposit amount managing device 10 the pre-paid card information given on the pre-paid card. This way, the user is able to increase the deposit amount in the deposit amount managing system 1 to a desirable amount.

When depositing money, the user may designate in which separate storages 281 to 283 the amount will be deposited. Alternatively, the deposit amount managing device 10 may automatically select in which separate storages 281 to 283 the amount will be deposited, depending on the currency of the amount to be deposited. When the deposit amount in the separate storage designated by the user meets a condition (e.g., deposit amount surpasses $1000), the deposit amount managing device 10 may automatically deposit the amount to another separate storage which is different from the separate storage designated by the user.

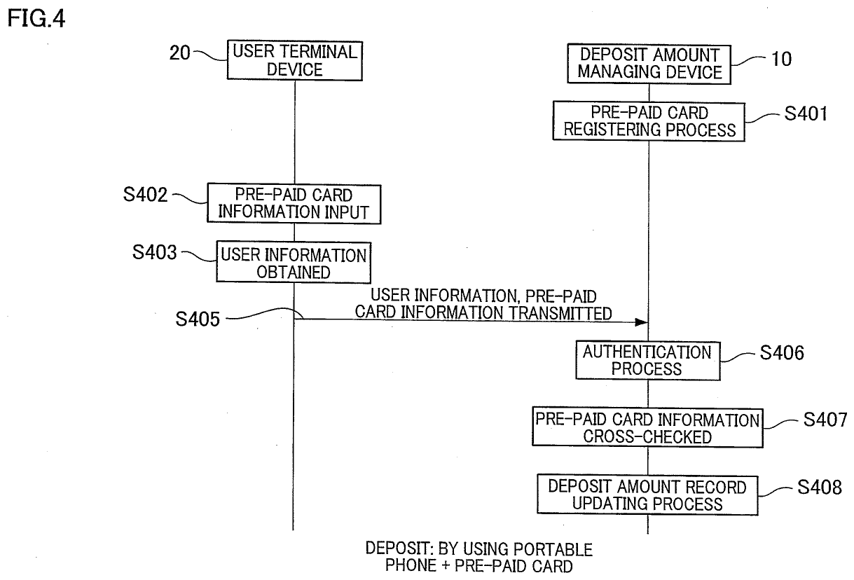

FIG. 4 is a sequence diagram showing an exemplary operation of the deposit amount managing system 1, at the time where the user having purchased a pre-paid card is depositing, into the deposit amount managing system 1, the entire or a part of the amount of money in the pre-paid card, by using a user terminal device 20.

First, the operator of the system 1 or the like causes the deposit amount managing device 10 to execute a pre-paid card registering process (S401). The pre-paid card registering process is a process for determining whether or not the pre-paid card information transmitted from the user is genuine, and writes in the pre-paid card DB 295 the pre-paid card information or information that enables authentication of the pre-paid card.

Pre-paid cards having undergone through the pre-paid card registering process are supplied to stores or the like. The user purchases the pre-paid card at any of the stores or the like. The amount of money paid for the purchase is entirely or partly (e.g., after subtracting selling service fees) deposited by the store or the like in the bank account of the operator of the system (illustration omitted).

To deposit, into the deposit amount managing system 1, an amount of money in the pre-paid card, the user transmits the pre-paid card information, the user information, or the like to the deposit amount managing device 10, by using the user terminal device 20. That is, the user inputs the pre-paid card information to the user terminal device 20 (S402). Specifically, for example, the user reads a number string of a predetermined number of digits printed on the pre-paid card, and inputs the number string to the user terminal device 20. Note the amount to be deposited may be contained in the pre-paid card information (the number indicating the amount of money may be contained in the number string). Alternatively, the amount to be deposited may be specified by the user information (the amount of money in the pre-paid card is stored in the pre-paid card DB 295).

Further, the user causes the user terminal device 20 to obtain the user information (S403). The user information may be manually input by the user. Alternatively, the user terminal device 20 may automatically obtain information (e.g., the unique number of the portable devices, the portable phone number, the user ID allotted and given in advance in the deposit amount managing device 10) stored in the storage device such as a memory.

Next, the user terminal device 20 transmits the pre-paid card information, the user information, or the like to the deposit amount managing device 10 via the communication network 30 (S405). When the pre-paid card information, the user information, or the like transmitted in S405 is received, the deposit amount managing device 10 (more specifically, deposit amount managing unit 230) causes the authentication unit 250 to execute an authentication process (S406). The authentication process is a process of comparing the user information transmitted by the user with the user information stored in the user DB 260. If these pieces of information match with each other, the depositing is approved as being regarded as a legitimate transaction.

Further, the deposit amount managing device 10 (more specifically, the deposit amount managing unit 230) cross-checks the pre-paid card information (S407). The cross-checking of the pre-paid card information is a process of determining whether or not the pre-paid card is genuine, and rejecting deposits by using a counterfeited or falsified pre-paid cards.

When the authentication process and the pre-paid card information are cross-checked and the user and the pre-paid card are determined as to be proper, the deposit amount managing device 10 (more specifically, the deposit amount managing unit 230) performs a deposit amount record updating process (S408). The deposit amount updating process is a process of updating the deposit amount in the deposit amount storage unit 270, according to the information transmitted from the user terminal device 20 or the like. This way, the deposit amount stored in the deposit amount storage unit 270 is rewritten to match the real situation (real condition), and a correct deposit amount is recorded.

When depositing an amount by using the pre-paid card, the amount of money in the pre-paid card is entirely or partly added to the amount stored in the user-designated one or more of separate storages 281 to 283 (or one or ones designated in the initial setting). Note that, when the currency of the amount of money in the pre-paid card and that of the separate storage to which an amount is additionally deposited are different, the deposit amount managing unit 230 activates the money exchange processing unit 240, and causes the money exchange processing unit 240 to convert the amount of money in the pre-paid card into the currency of the separate storage. The amount after the conversion is then added to the amount stored in the separate storage. The money exchange processing unit 240 connects to the money exchanging server 60 via the communication network 30, and obtains an exchange rate for converting the currency of the pre-paid card to that of the separate storage. Based on this exchange rate, the amount of money in the pre-paid card is converted into the currency of the separate storage. This process of converting currency is referred to as money exchange process. Note that the deposit amount managing unit 230 may subtract a service fee for the money exchange process from the deposit amount of any of the separate storages.

### [2.2.2. Store Terminal Device and Cash]

The user may deposit cash in the deposit amount managing system 1 through the store terminal device 40. The user goes to a store in which a store terminal device 40 is installed, and hands to an operator of the store terminal device 40 (store clerk or the like) the cash corresponding to the amount to be deposited in the deposit amount managing system 1. The operator having received the cash stores the cash in a storage such as a cash register or a safe, and operates the store terminal device 40 to add the amount of money corresponding to the cash received to the deposit amount of the user in the deposit amount managing device 10. This way, the user is able to increase the deposit amount in the deposit amount managing system 1 to a desirable amount.

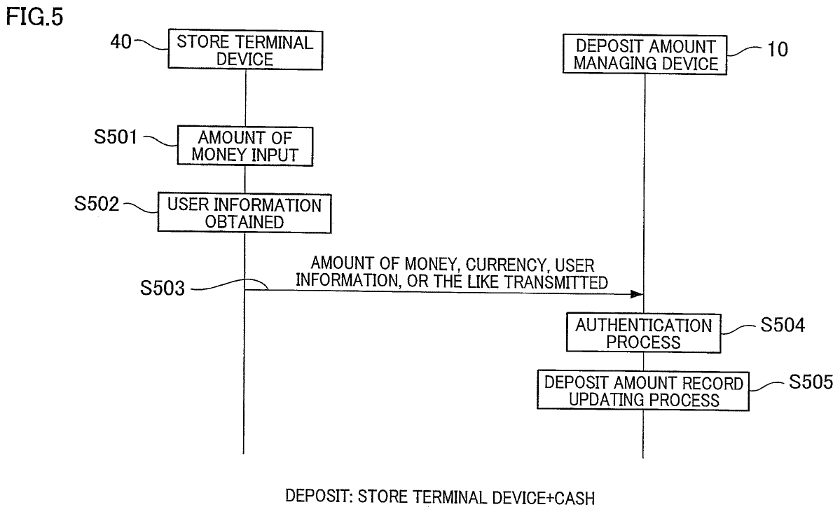

FIG. 5 is a sequence diagram showing an exemplary operation of the deposit amount managing system 1, at the time where an amount corresponding to the cash received from the user is deposited in the deposit amount managing system 1 by using the store terminal device 40.

First, the operator of the store terminal device 40 inputs the amount received by using an input device (keyboard, or the like) of the store terminal device 40 (S501). The currency type may be input at this point. Next, a part of the user information is input to the store terminal device 40 (S502). In this case, the user information that needs to be input is information needed to execute the later-mentioned authentication process (S504). For example, the user information needed is the user ID and the password. The user information may be input as follows in S502. Namely, a separate input device such as a numeric keypad with a blindfold board; e.g., CAT (Credit Authorization Terminal), may be connected to the store terminal device 40, and the user him/herself may use this separate input device to input his/her user information. This is for the sake of keeping the user information secret.

When the amount of money (with indication of the currency type) and the user information are input, the store terminal device 40 establishes a connection to the deposit amount managing device 10 via the communication network 30, and transmits the amount of money (with indication of the currency type) and the user information to the deposit amount managing device 10 (S503).

When the amount of money (with indication of the currency type) and the user information are received, the deposit amount managing device 10 executes the authentication process (S504) and the deposit amount record updating process (S505). The description of the authentication process (S504) and the deposit amount record updating process (S505) are omitted here, for the reason that these processes are the same as the authentication process (S406) and the deposit amount record updating process (S408) described hereinabove.

### [2.2.3. Automatic Teller Machine and Cash]

The user may deposit cash in the deposit amount managing system 1 through the automatic teller machine 50. The user goes to the automatic teller machine 50, and inputs into the automatic teller machine 50 cash corresponding to the amount he/she wishes to deposit in the deposit amount managing system 1. The automatic teller machine 50 adds the amount of money corresponding to the cash received, to the deposit amount of the user in the deposit amount managing system 1. This way, the user is able to increase the deposit amount in the deposit amount managing system 1 to a desirable amount (in the desirable currency).

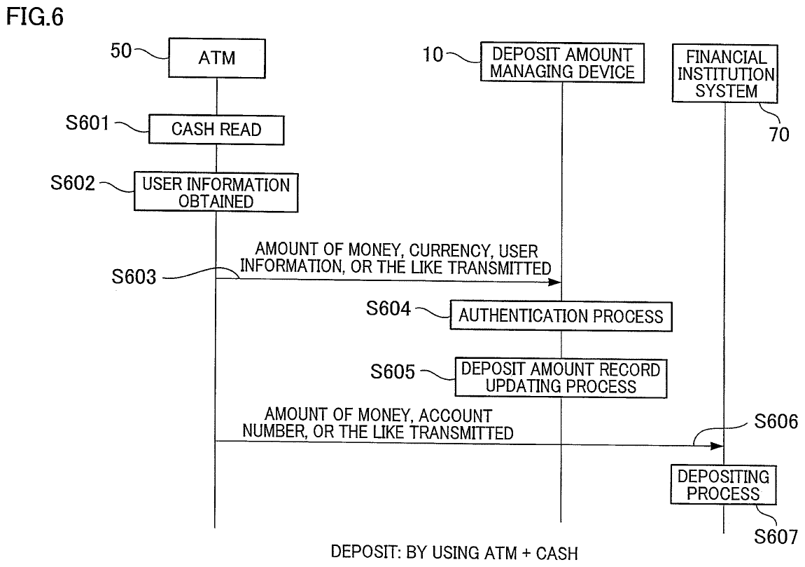

FIG. 6 is a sequence diagram showing an exemplary operation of the deposit amount managing system 1 at the time where the user deposits an amount in the deposit amount managing system 1 by using the automatic teller machine 50. When the user inputs cash corresponding to an amount of money he/she wishes to deposit, into a cash insertion slot of the automatic teller machine 50, the automatic teller machine 50 reads the amount and the currency of the cash having been input (S601). Next, the automatic teller machine 50 prompts the user to input a part of the user information. In this case, the user information that needs to be input is information needed to execute the later-mentioned authentication process (S604). For example, the user information needed is the user ID and the password. When the necessary user information is input, the automatic teller machine 50 obtains the information (S602). At this point, the user information such as the user ID and the password may be obtained through communication with the contactless IC card chip of the user terminal device 20, which enables short-distance communication.

Next, the automatic teller machine 50 establishes a connection to the deposit amount managing device 10 via the communication network 30, and transmits the amount of money (with indication of the currency type) and the user information to the deposit amount managing device 10 (S603). When the amount of money (with indication of the currency type) and the user information are received, the deposit amount managing device 10 executes the authentication process (S604) and the deposit amount record updating process (S605). The description of the authentication process (S604) and the deposit amount record updating process (S605) are omitted here, for the reason that these processes are the same as the authentication process (S406) and the deposit amount record updating process (S408) described hereinabove.

Further, the automatic teller machine 50 establishes connection to the financial institution system 70 via the communication network 30, and transmits to the financial institution system 70 the amount of money corresponding to the cash read in S601 and the account to receive the transferred cash (e.g., the bank account of the operator of the deposit amount managing system 1) (S606). The financial institution system 70 then executes a depositing process for depositing the amount of money having been transmitted in S606 into the account (S607). Thus, the amount of money corresponding to the cash having been input to the automatic teller machine 50 is deposited into the account for keeping the cash.

### [2.3. Withdrawal of Money]

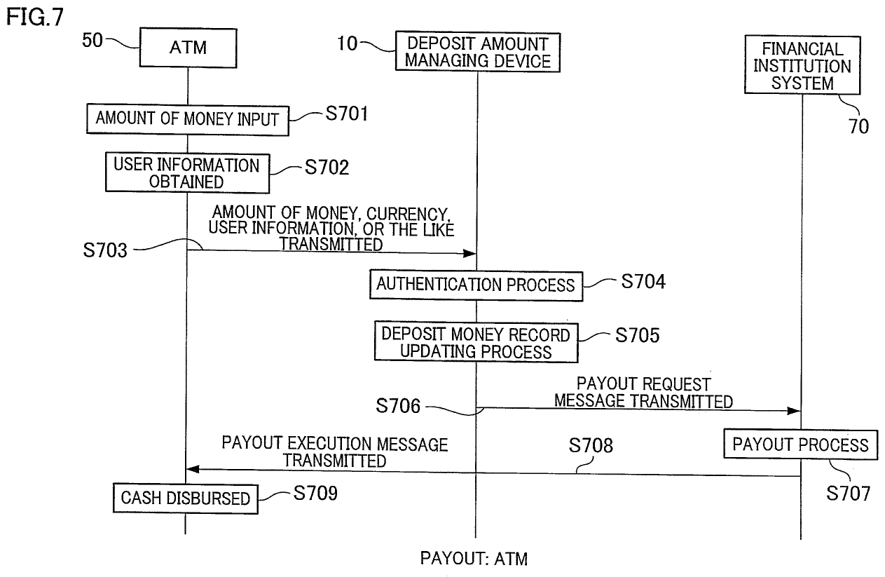

The user of the deposit amount managing system 1 may withdraw a desirable amount of money in cash from the deposit amount in the deposit amount managing system 1. FIG. 7 is a sequence diagram showing an exemplary operation of the deposit amount managing system 1 at the time of withdrawing cash from the deposit amount of the deposit amount managing system 1 through the automatic teller machine 50.

First, the user inputs an amount of money he/she wishes to withdraw to the automatic teller machine 50 (S701). At this time, the user may designate from which separate storage and/or in which currency the cash will be withdrawn.

Next, the automatic teller machine 50 prompts the user to input a part of the user information. In this case, the user information that needs to be input is information needed to execute the later-mentioned authentication process (S704). For example, the user information needed is the user ID and the password. When the necessary user information is input, the automatic teller machine 50 obtains the information (S702).

Next, the automatic teller machine 50 establishes a connection to the deposit amount managing device 10 via the communication network 30, and transmits the amount of money (with indication of the currency type) and the user information to the deposit amount managing device 10 (S703). When the amount of money (with indication of the currency type) and the user information are received, the deposit amount managing device 10 executes the authentication process (S704) and the deposit amount record updating process (S705). The description of the authentication process (S704) and the deposit amount record updating process (S705) are omitted here, for the reason that these processes are the same as the authentication process (S406) and the deposit amount record updating process (S408) described hereinabove. Note however that the deposit amount record updating process (S705) is different in that the amount of money designated (see S701) is subtracted from the deposit amount.

Next, the deposit amount managing device 10 establishes connection to the financial institution system 70 via the communication network 30, and transmits to the financial institution system 70 a payout request message containing information of the amount of money input in S701 and the account (e.g., the bank account of the operator of the deposit amount managing system 1) from which the cash is withdrawn (S706). The financial institution system 70 then executes a payout process in which the amount of money having been transmitted in S706 is withdrawn from the account (S707). This way, the amount of money requested by the user is withdrawn in cash from the account.

The financial institution system 70 transmits to the automatic teller machine 50 a payout execution message instructing payout of the amount of money in cash (S708). When the payout execution message is received, the automatic teller machine 50 outputs the amount of money from the cash stored therein, and provides the user with the amount of money in cash (S709). This way, the user is able to obtain a desirable amount of cash from the money being deposited.

### [2.3.1. One-Touch Withdrawal of Money]

The above method of withdrawing money requires the user to input an amount of money and the user information. This leaves some inconvenience when the user needs to obtain cash quickly. The following describes an alternative form of the present invention which enables withdrawal of cash through a simple operation in the deposit amount managing system 1.

In this alternative form, the user terminal device 20 has a contactless IC card chip capable of performing short-distance wireless communication. This IC card chip is capable of communicating with a later described IC card reader/writer. Further, the automatic teller machine 50 has the reader/writer and is capable of communicating with the IC card chip of the user terminal device 20.

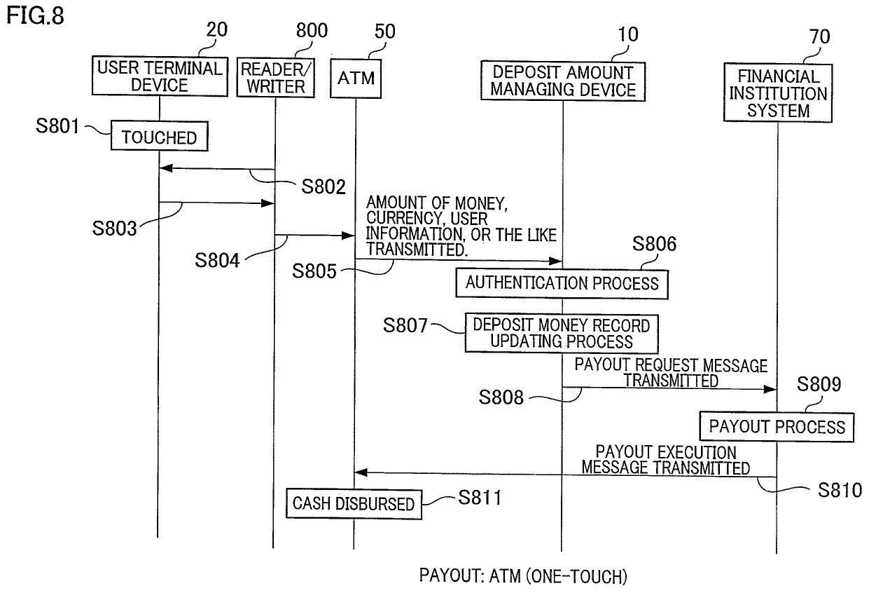

FIG. 8 is a sequence diagram showing an exemplary operation of the deposit amount managing system 1 at the time where cash is withdrawn from the deposit amount in the deposit amount managing system 1 of the present alternative form. First, the user goes to an automatic teller machine 50 having the reader/writer 800. Then, the user brings the user terminal device 20 having the contactless IC card chip to a distance at which the reader/writer 800 is able to read (S801). The reader/writer 800 transmits to the IC card chip (not shown) a message to activate a predetermined application (e.g., I-apli (NTT Docomo®)) (S802). The IC card chip of the user terminal device 20 stores in advance: the entire or a part of the user information; and an application in which a predetermined amount of money and a predetermined separate storage is registered. This application is activated in response to the message having been transmitted in S802, and transmits the entire or a part of the user information, and information of the predetermined amount of money and the predetermined separate storage to the reader/writer 800 (S803). This transmission of the user information or the like by the application requires no operation by the user, and is automatically performed by the application.

When the entire or a part of the user information and the information of the predetermined amount of money and the predetermined separate storage are received from the IC card chip of the user terminal device 20, the reader/writer 800 transmits these pieces of information to the automatic teller machine 50 (S804).

Next, the automatic teller machine 50 establishes a connection to the deposit amount managing device 10 via the communication network 30, and transmits the amount of money (with indication of the currency type) and the user information to the deposit amount managing device 10 (S805). When the amount of money (with indication of the currency type) and the user information are received, the deposit amount managing device 10 executes the authentication process (S806) and the deposit amount record updating process (S807). The description of the authentication process (S806) and the deposit amount record updating process (S807) are omitted here, for the reason that these processes are the same as the authentication process (S704) and the deposit amount record updating process (S705) described hereinabove.

Next, the deposit amount managing device 10 establishes connection to the financial institution system 70 via the communication network 30, and transmits to the financial institution system 70 a payout request message containing information of the amount of money transmitted in S805 and the account (e.g., the bank account of the operator of the deposit amount managing system 1) from which the cash is withdrawn (S808). The financial institution system 70 then executes a payout process in which the amount of money having been transmitted in S805 is paid out from the account (S809). This way, the designated amount of money is paid out in cash from the account.

The financial institution system 70 transmits to the automatic teller machine 50 a payout execution message instructing payout of the amount of money in cash (S810). When the payout execution message is received, the automatic teller machine 50 outputs the amount of money from the cash stored therein, and provides the user with the amount of money in cash (S811). This way, the user is able to obtain a desirable amount of cash from the money being deposited.

With the above alternative form, the user is able to promptly receive cash, without being troubled by the operation of inputting the amount of money and the user information.

### [2.4. Remittance]

The user of the deposit amount managing system 1 may send remittance of a desirable amount within the range of the deposit amount to a designated bank account by means of money transfer. Further, even when the user has no bank account, the deposit amount managing system enables sending of remittance between individual user deposit amount storage units 280 managed by the system. Further, it is possible to send remittance to the individual user deposit amount storage unit 280 of the deposit amount managing system by using an electronic money (e.g. PAYPAL, or the like) of a different company.

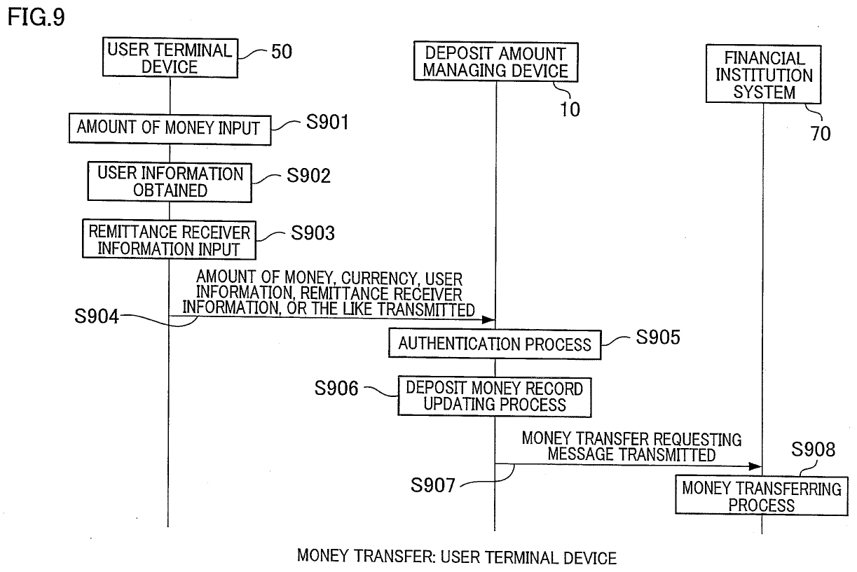

FIG. 9 is a sequence diagram showing an exemplary operation of the deposit amount managing system 1 at the time of sending remittance from the deposit amount in the deposit amount managing system 1.

When sending remittance using the system 1, the user first inputs to the user terminal device 20 an amount of remittance he/she wishes to send (S901). At this time, the user may designate from which separate storage and/or in which currency the remittance is send.

Next, the user inputs a part of the user information (S902). In this case, the user information that needs to be input is information needed to execute the later-mentioned authentication process (S905). For example, the user information needed is the user ID and the password. When the necessary user information is input, the user terminal device 20 maintains the information.

The user then inputs information specifying the bank account to receive the remittance (hereinafter, remittance receiver information) on the user terminal device 20 (S903). Specifically, the remittance receiver information is for example, the name of the bank of the remittance receiving account, the name of the branch, type of the account, the account number, the name of account holder, or the like.

When the S901 to S903 are completed, the user terminal device 20 establishes a connection to the deposit amount managing device 10 via the communication network 30, and transmits the amount of money (with indication of the currency type), the user information, and the remittance receiver information to the deposit amount managing device 10 (S904). When the amount of money (with indication of the currency type), the user information, and the remittance receiver information are received, the deposit amount managing device 10 executes the authentication process (S905) and the deposit amount record updating process (S906). The description of the authentication process (S905) and the deposit amount record updating process (S906) are omitted here, for the reason that these processes are the same as the authentication process (S704) and the deposit amount record updating process (S705) described hereinabove.

Next, the deposit amount managing device 10 establishes connection to the financial institution system 70 via the communication network 30, and transmits to the financial institution system 70 a money transfer requesting message containing information of the amount of money (amount of remittance) input in S901, the account (e.g., the bank account of the operator of the deposit amount managing system 1) from which cash is withdrawn, and the remittance receiver account (S907). According to this money transfer requesting message, the financial institution system 70 executes a money transferring process. In this process, the remittance is sent from the bank account from which the amount of remittance is withdrawn to the account to receive the remittance (S908). This way, cash corresponding to the amount of money requested by the user is transferred from the deposit amount of the user to the bank account to receive the remittance. At this time, a predetermined service fee may be collected as needed.

Note that, in the above example, the user made the remittance request by using the user terminal device 20. However, the present invention encompasses a structure in which the user uses the store terminal device 40 or the automatic teller machine 50 instead of the terminal device 20.

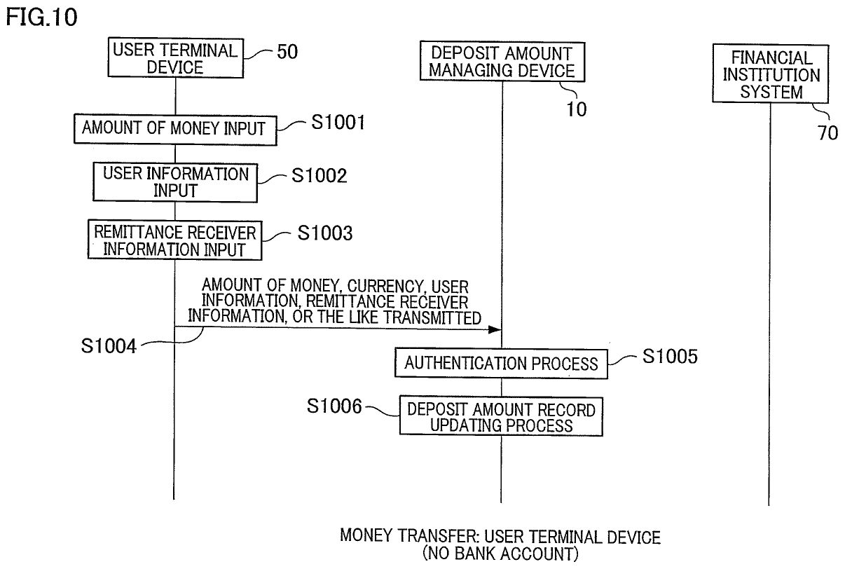

FIG. 10 is a sequence diagram showing an exemplary operation of the deposit amount managing system 1 at the time of sending remittance to a user having no bank account.

The user may send remittance by moving a desirable amount of money within the range of his/her deposit amount, to the deposit money of a designated user to receive the remittance. Basically, there is executed a process similar to the process of sending remittance to a bank account, which is described with reference to FIG. 9. The steps S1001 to S1005 shown in FIG. 10 are the same as the steps S901 to S905 of FIG. 9. Therefore, details of these steps are omitted here. However, in S1003, the information of the remittance receiving user (e.g., user ID) is input, instead of the information of the bank account to receive the remittance.

In S1006, the deposit amount managing device 10 executes a process of subtracting an amount of remittance from the deposit amount of the user sending the remittance and adding the amount of remittance to the deposit amount of the user designated as the remittance receiver, according to the message received from the user terminal device 50 in S1004. Note that a service fee for sending remittance may be collected from one of or the both of the deposit amounts. Thus, the remittance is made between users. There is no need of making a request of money transfer to the financial institution system 70. Further, it is possible to perform remittance of prize money of a lottery, or remittance of refund money, as needed, in addition to the remittance between users.

### [2.5. Making Payment]

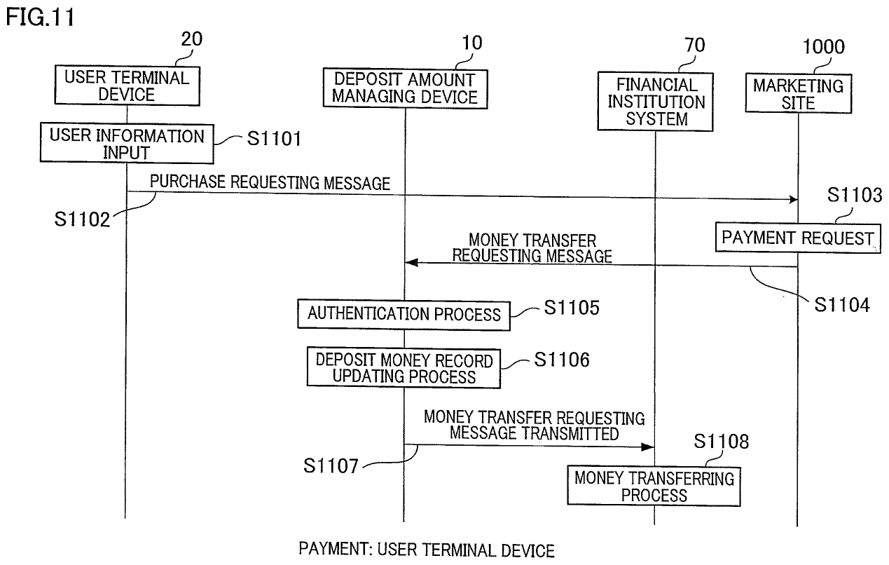

The user of the deposit amount managing system 1 is able to make a payment from the deposit amount in the deposit amount managing system 1. FIG. 11 is a sequence diagram showing an exemplary operation of the deposit amount managing system 1 at the time of making a payment from the deposit amount in the deposit amount managing system 1, in cases where the user purchases through the web a product, a service, or the like (e.g., sports lottery) by using the user terminal device 20.

Suppose that the user browses a marketing site on the web by using the user terminal device 20, finds a product or a service he/she wants on the site, and planning to purchase the product or the service.

First, the user causes the user terminal device 20 to obtain the user information (S1101). The user information may be manually input by the user. Alternatively, the user terminal device 20 may automatically obtain information (e.g., unique number of the portable device, portable phone number, the user ID allotted and given in advance in the deposit amount managing device 10) stored in the storage device such as a memory.

Next, the user transmits a purchase requesting message to the marketing site 1000 (S1102). For example, the purchase requesting message is transmitted to the marketing site 1000 via the communication network 30 by, for example, clicking to activate a “purchase button” in a screen of the marketing site which is displayed on the user terminal device 20. This message is given the user information or the like having been input in S1101.

The marketing site 1000 having received the purchase requesting message executes a payment requesting process for requesting the user to make a payment for the purchase (S1103). In this payment requesting process, the marketing site 1000 transmits a payment requesting message to the deposit amount managing device 10 (S1104). To this payment requesting message are given the user information, a payment due (the currency type may be designated), information of the bank account for receiving remittance of the payment money.

When the payment requesting message containing the user information, the amount of payment due (the currency type may be designated), the information of the bank account to receive the remittance of the payment is received, the deposit amount managing device 10 executes an authentication process (S1105) and a deposit amount record updating process (S1106). The authentication process (S1105) and the deposit amount record updating process (S1106) are the same as the authentication process (S905) and the deposit amount record updating process (S906) described hereinabove. Therefore, description for these steps are omitted here.

Next, the deposit amount managing device 10 establishes connection to the financial institution system 70 via the communication network 30, and transmits to the financial institution system 70 a money transfer requesting message containing information of the bank account from which the amount of money to be remitted is withdrawn (e.g., the bank account of the operator of the deposit amount managing system 1), and the information of a bank account for receiving the remittance (S1107). According to this money transfer requesting message, the financial institution system 70 executes a money transferring process. In this process, the remittance is sent from the bank account from which the amount of remittance is withdrawn to the account to receive the remittance (S1008). This way, the amount of money to be paid which is requested by the marketing site 1000 is transferred from the deposit amount of the user to the bank account to receive the remittance. At this time, a predetermined service fee may be collected as needed. When the web is not used, if the payment receiver can be specified by the user terminal 20; e.g., utility charges or payment for purchasing a lottery, it is possible to make a payment by transmitting a request message for remittance process, containing the user information and the amount of payment due (the currency type may be designated). It is possible to specify the payment receiver by a specific account number in the deposit amount managing system, a phone number, or by giving a specific number. In this case, the deposit amount managing system 1 executes a process similar to that described in the above [2.4. Remittance].

### [2.6. Balance Confirmation]

The user of the deposit amount managing system 1 is able to confirm his/her deposit amount anytime. The user causes the user terminal device 20 to transmit a balance confirmation request message containing the user information to the deposit amount managing device 10. In reply, the user terminal device 20 receives, in the form of message, the contents of all the separate storages in one individual user deposit amount storage unit 280 of the deposit amount storage unit 270. This way, the user is able to confirm anytime the amount of money (balance) deposited in the deposit amount managing device 10.

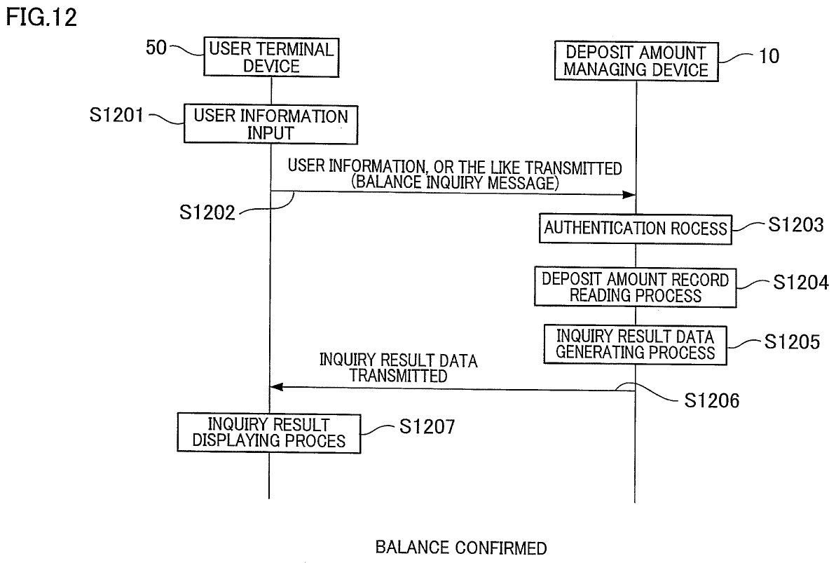

FIG. 12 is a sequence diagram showing an exemplary operation of the deposit amount managing system 1 at the time where the user requests balance confirmation of his/her deposit amount. The following describes the exemplary operation of the deposit amount managing system 1 with reference to FIG. 12.

When the user wishes to know his/her deposit balance, the user inputs to the user terminal device 50 the user information for specifying the user (S1201). Note that, in this exemplary operation, the device used for confirming the balance is the user terminal device 50. The present invention however is not limited to such a structure, provided that the device for confirming the balance is a device capable of communicating with the deposit amount managing device 10: e.g., an automatic teller machine, a cash dispenser, a terminal at a convenience store, a POS terminal installed at a store.

Further, the user information does not necessarily have to be input by the user, and it is possible to use information stored in advance in the user terminal device 50. For example, such information is the individual information of the portable phone, the phone number, and a separately given user ID. The input of the user information may be performed by having the user terminal device 50 obtain such information stored in the storage device of the user terminal device 50 (S1201).

Next, the user terminal device 50 having obtained the user information generates a balance inquiry message which is a message containing the user information, and which requests notification of the deposit balance of the user specified by the user information. The user terminal device 50 then transmits the message to the deposit amount managing device 10 (S1202).

The deposit amount managing device 10 having received the message executes an authentication process (S1203). This authentication process is the same as the authentication process (S406, S504) described above. Therefore, further explanation is omitted.

When the authentication process is successful, the deposit amount managing device 10 executes a deposit amount record reading process which is a process of reading out the contents of the individual user deposit amount storage unit 280 corresponding to the user specified by the user information (S1204). In this case, the contents of all the first to third separate storages 281 to 283 may be read out, or the contents of a user-designated one or more of the separate storages may be read out.

Next, based on the contents of the individual user deposit amount storage unit 280 having been read out in the S1204, the deposit amount managing device 10 generates message data (hereinafter, inquiry result data) for notifying the user of the deposit amount (S1205). For example, the message data is text data reading “Dear @@, Your deposit balance as of Jun. 30, 2009 is as follows. First pocket: 100 Dollars, Second Pocket: 20 EUR, Third Pocket: 3000 BRL”.

Next, the deposit amount managing device 10 transmits the inquiry result data generated in S1205 to the user terminal device 50 (S1206). Note that the method of communicating the inquiry result data may be any given method. Electronic mail and short mail messages (SMS) are possible. It is also possible to adopt a method in which the user terminal device 50 obtains and displays the message data.

The user terminal device 50 having received the inquiry result data outputs the contents of the inquiry result data in a method that allows the user to know. This method of outputting may be displaying on a liquid crystal display, or audio output from a speaker.

Note that the user may designate a device other than the user terminal device 50 as the inquiry result data receiving end, and cause the deposit amount managing device 10 to transmit the inquiry result data to that device.

Thus, the first embodiment is described with reference to FIG. 1 to FIG. 12. The first embodiment deals with a case where the payment is made from the deposit amount in the deposit amount managing device, when a product or service is purchased through the web. The deposit amount managing device of the present invention however is not limited to this. For example, the deposit amount managing device of the present invention is suitable for making a payment or receiving a payment in relation to a sportsbook.

### Second Embodiment

In the second embodiment, the above described aspect (6) of the present invention is described. In the following description, the structuring elements that are identical to those of the deposit amount managing device described in the above embodiment are given the same reference symbols. Further, descriptions are omitted for those parts of the second embodiment which are as described in the above embodiment.

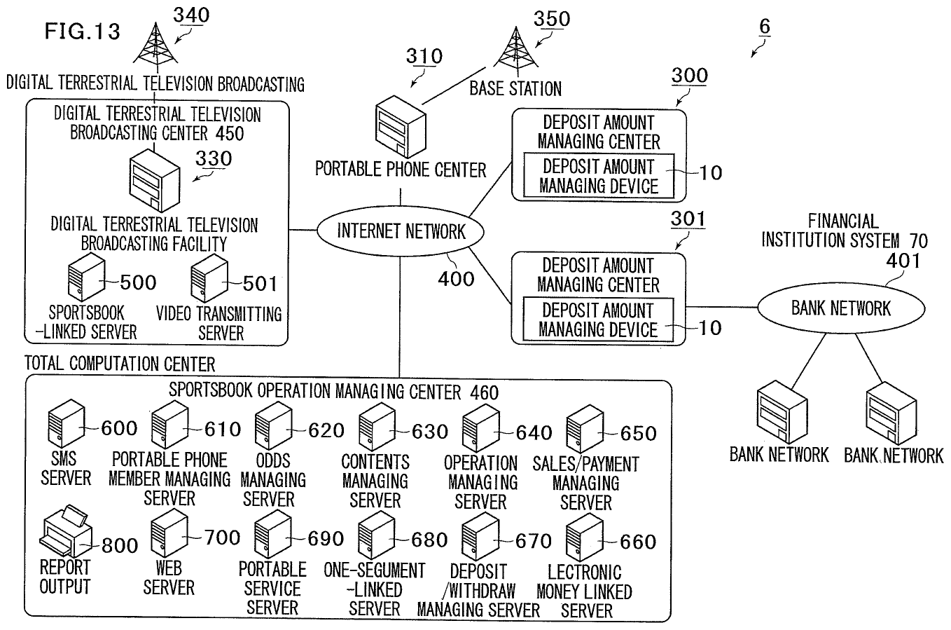

The following describes the second embodiment with reference to FIG. 13. FIG. 13 shows a service providing system related to the second embodiment of the present invention. Note that the service providing system 6 related to the second embodiment of the present invention has the deposit amount managing device 10 of the first embodiment.

As shown in FIG. 13, the service providing system 6 of the present embodiment includes: a sportsbook operation managing center 460, a deposit amount managing center 300 (deposit amount managing center 301), a digital terrestrial television broadcasting managing center 450, a portable phone center 310, and a financial institution system 70 which are connected to the internet network 400 and which are therefore in communication with one another via the internet network 400.

With the service providing system 6 of the present embodiment, the user is able to play at a sportsbook without a need of opening his/her own account at a financial institution. A sportsbook is run in the service providing system 6 of the present embodiment. Data indicative of a result of a soccer game predicted by a player (hereinafter, also referred to as result prediction) is transmitted from the user terminal device 20 to the sportsbook operation managing center 460. When the result prediction matches the actual result of the soccer game, the sportsbook operation managing center 460 determines the amount of money won, and transmits data indicative of the amount of money won to the deposit amount managing device 10. The deposit amount managing device 10 increases, by the amount of money won, the deposit amount in one of deposit accounts which corresponds to a user having made the prediction (the deposit accounts are hereinafter also referred to as user deposit accounts), while transmitting to the financial institution system 70 information that the amount in the bank account of the bookmaker (manager) (hereinafter, bookmaker bank account) is decreased by the amount of money won. Note that the deposit accounts are stored in the deposit amount storage unit of the deposit amount managing device 10. Each of the deposit accounts stores the deposit amount of one user. The deposit amount storage unit corresponds to the storage means of the aspects (6) to (8).

The service providing system 6 of the present embodiment has a sportsbook operation managing center 460 (see FIG. 13). As shown in FIG. 13, the sportsbook operation managing center 460 has various servers. For example, an SMS server 600 is a server for storing a communication history or the like between the user terminal device 20 and the sportsbook operation managing center 460. A portable phone member managing server 610 is a server for storing portable phone member registration data (data indicating for each member, the portable phone number, or the like), or the like. An odds managing server 620 is a server for storing the odds or the like related to the games to be the bet targets. A contents managing server 630 is a server for storing the web page, or the like, of the bookmaker site. The servers provided to the sportsbook operation managing center 460 are not limited to those shown in FIG. 13. That is, the SMS server 600 may serve as a server for storing the web page or the like of the bookmaker site. Further, the functions of all the servers shown in FIG. 13 may be realized by a single server. Note that the servers provided to the sportsbook operation managing center 460 correspond to the bookmaker managing server of the aspects (6) to (7).

As shown in FIG. 13, the service providing system 6 of the present embodiment includes a digital terrestrial television broadcasting managing center 450. The digital terrestrial television broadcasting managing center 450 has a sportsbook-linked server 500 which receives, from the odds managing server 620, odds data or the like indicative of odds in the sportsbook. The sportsbook-linked server 500 is a server for storing the odds data or the like received from the odds managing server 620.

As shown in FIG. 13, the service providing system 6 of the present embodiment includes a portable phone center 310 and a base station 350.

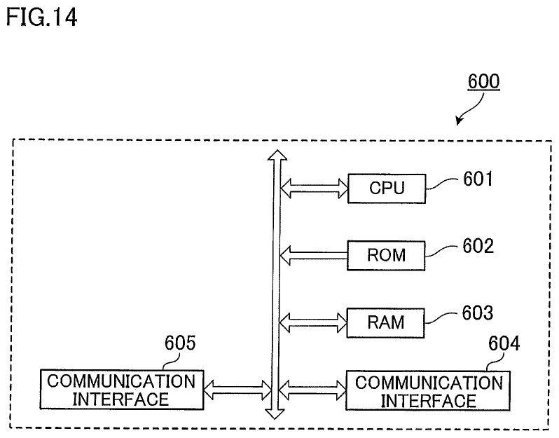

FIG. 14 is a block diagram showing an internal structure of the SMS server 600 of the sportsbook operation managing center 460 related to the second embodiment of the present invention. Note that the present embodiment describes the internal structure of only the SMS server 600 among the servers provided in the sportsbook operation managing center 460. This is because the internal structures of the servers of the sportsbook operation managing center 460 are substantially the same as that of the SMS server 600.

The SMS server 600 includes a CPU 601, a ROM 602, a RAM 603, and communication interfaces 604, 605. The communication interface 604 connects to communication interfaces 44 of the servers of the sportsbook operation managing center 460, via a communication line. The ROM 602 stores a system program for controlling the operation of the CPU 601, permanent data, or the like.

RAM 603 temporarily stores data received from the user terminal device 20, or the like. The RAM 603 is provided with a SMS history storage area for storing SMS history data indicative of transmission/reception history of SMS (short message service). The SMS history storage area stores SMS history data indicative of the transmission/reception history of SMS.

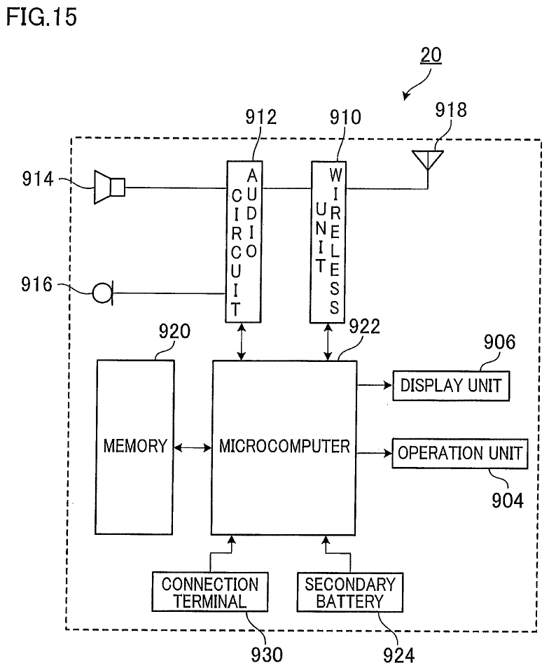

FIG. 15 is a block diagram indicating an internal structure of the user terminal device 20. Note that the user terminal device 20 corresponds to the portable terminal of the aspects (5) to (8). The user terminal device 20 has a control panel 904, a display unit 906, a wireless unit 910, an audio circuit 912, a speaker 914, a microphone 916, transmission/reception antenna 918, an involatile memory 920, a micro computer 922, a secondary battery 924, and a connection terminal 930.

The wireless unit 910 under control of the micro computer 922 transmits/receives electromagnetic waves serving as media, to the base station 350 through the transmission/reception antenna 918. The audio circuit 912 outputs, to the speaker 914, received signals received from the wireless unit 910 via the micro computer 922, and outputs audio signals from the microphone 916 as transmitted signals to the wireless unit 910 via the micro computer 922.

The speaker 914 converts the received signals from the audio circuit 912 into received audio and outputs the audio. The microphone 916 converts transmitted audio from the operator to audio signals and outputs the signals to the audio circuit 912.

The involatile memory 920 is an involatile storage for image data of a standby image, and various programs (web browser program, BML browser program). The secondary battery 924 supplies power to each circuit. The micro computer 922 is structured by a CPU, a ROM, and a RAM, and executes, for example, a call/call-receiving process, a mail drafting and transmission/reception process, an internet process, or the like. Note that transmission/reception of electronic mails and data transmission/reception through the internet are executed by the micro computer 922 via the wireless unit 910 and the transmission/reception antenna 918.

Thus, the internal structure of the user terminal device 20 is described with reference to FIG. 15.

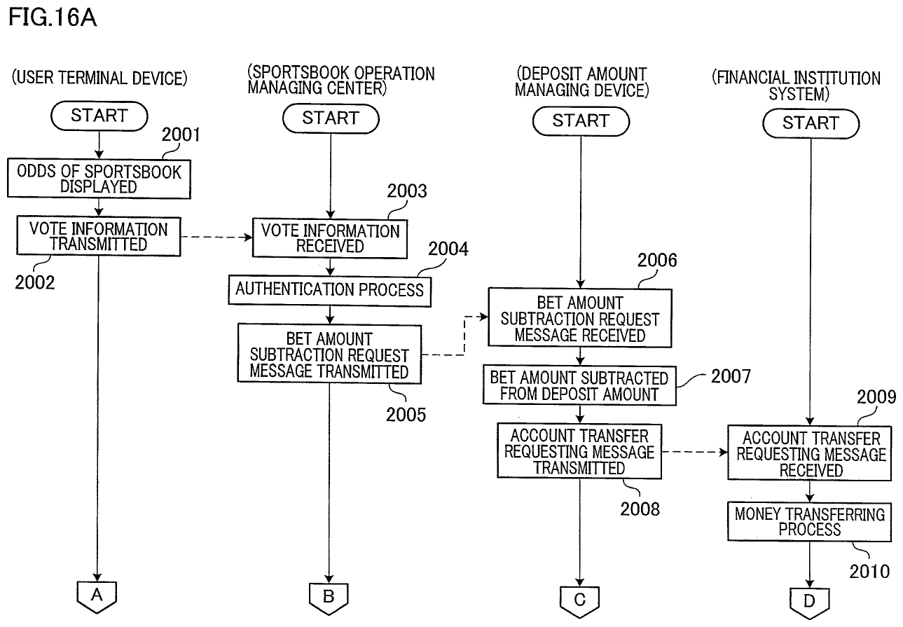

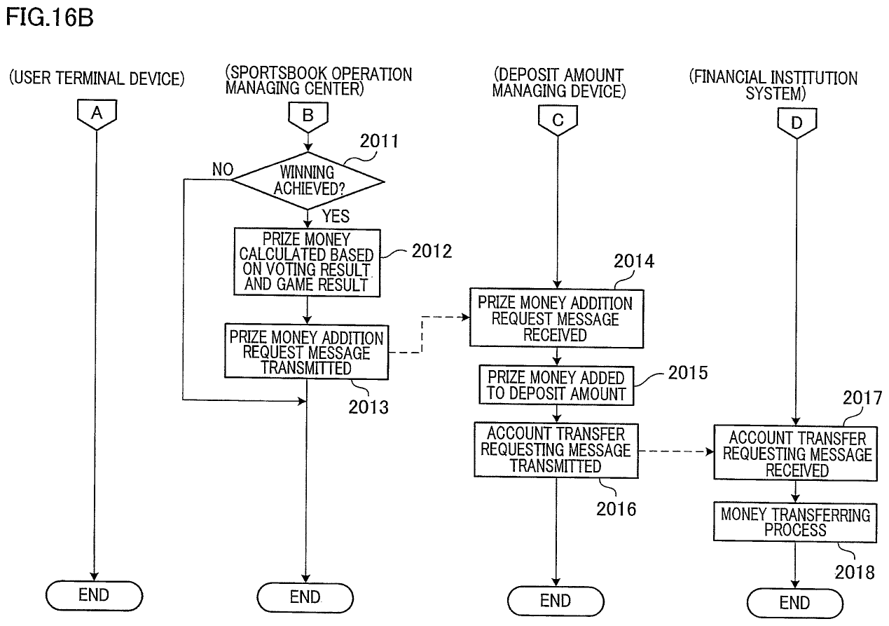

Next, the following describes an exemplary operation of the service providing system 6 of the present embodiment with reference to FIG. 16A and FIG. 16B. FIG. 16A and FIG. 16B are sequence diagrams showing the exemplary operation of the service providing system 6 related to the second embodiment. Note that the steps S2003 to S2005 of FIG. 16A and S2011 to S2013 of FIG. 16B are processes executed by a predetermined server provided to the sportsbook operation managing center 460.

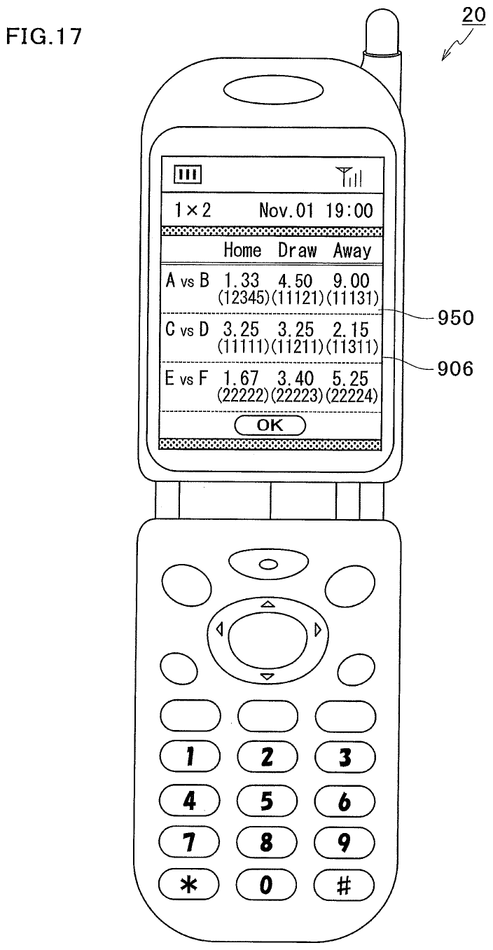

The user terminal device 20 displays an odds display image 950 showing odds of the sportsbook on the display unit 906 (S2001) (see FIG. 17).

The following describes the odds display image 950 with reference to FIG. 17. FIG. 17 shows the odds display image 950 displayed on the display unit 906 of the user terminal device related to the second embodiment. In the present embodiment, an odds notification mail is transmitted from the sportsbook operation managing center 460 to the user terminal device 20 in the form of SMS. The odds notification mail contains text shown in the odds display image 950. The odds notification mail is transmitted from the sportsbook operation managing center 460 to the user terminal device 20, thirty minutes before the game serving as a bet target. That is, the sportsbook operation managing center 460 has a timer. When the sportsbook operation managing center 460 determines that it is thirty minutes before the game serving as the bet target, the sportsbook operation managing center 460 transmits the odds notification mail to the user terminal device 20. As shown in the odds display image 950 of FIG. 17, a five-digit number and odds are displayed for each of the possible game results (e.g., A's win, Draw, or B's win) in relation to a game serving as the bet target (e.g., a game of A vs. B). The five-digit number is a text string for designating any of the possible game results. In the example shown in FIG. 17, the odds corresponding to A's win is 1.33. That is, when the user bets $100 on A's win, and if A wins the game, the amount of money won will be $133.

After S2001, the user terminal device 20 transmits a vote information to the phone number assigned to the sportsbook operation managing center 460 (S2002). The user then transmits the bet amount and the five-digit number to the sportsbook operation managing center 460 by using SMS. Further, the user may transmit, to the sportsbook operation managing center 460, the password set for each user and the phone number assigned to the user terminal device 20 on the transmitting end. For example, when $100 is bet on A's win, the player may transmit a mail containing text reading “12345#100” and the password. In this mail is also transmitted information indicative of the phone number assigned to the user terminal device 20 on the transmitting end. Note that in the present embodiment, information indicating the bet amount, the five-digit number, the password, and the phone number assigned to the user terminal device 20 on the transmitting end is referred to as vote information. Of the vote information, the information indicative of the five-digit number corresponds to the selection information of the aspect (6). Of the vote information, the information indicative of the phone number assigned to the user terminal device 20 on the transmitting end corresponds to the user identification information of the aspects (6) to (7). Note that in the present invention, the vote information may contain an ID number of a SIM card instead of the phone number. Further, the vote information may contain biological information (e.g., finger prints) along with the password, or in place of the password. In this case, the user terminal device may have a device capable of reading the biological information.

The sportsbook operation managing center 460 receives the vote information transmitted from the user terminal device 20 (S2003). When the sportsbook operation managing center 460 executes S2003, the predetermined server of the sportsbook operation managing center 460 corresponds to the selection information receiving means of the aspect (6).

After receiving the vote information, the sportsbook operation managing center 460 specifies the deposit account (user deposit account) corresponding to the user, based on the phone number and the password of the user terminal device 20 indicated by the vote information, and the portable phone member registration data (data indicating for each user the corresponding portable phone number, the password, and the deposit account) (S2004). Note that, when the user is not specified, because the password or the phone number of the user terminal device 20 indicated by the vote information does not match with that indicated by the portable phone member registration data, the sportsbook operation managing center 460 transmits to the user terminal device 20 a mail indicating that participation of the user in the sportsbook is not permitted.

The sportsbook operation managing center 460 transmits to the deposit amount managing device 10 information indicative of the deposit account specified in S2004 and an amount of money (bet amount) (the information is hereinafter also referred to as bet amount subtraction request message) (S2005).

After receiving the bet amount subtraction request message from the sportsbook operation managing center 460 (S2006), the deposit amount managing unit 230 of the deposit amount managing device 10 subtracts the bet amount indicated by the bet amount subtraction request message, from the amount in the deposit account (user deposit account) indicated by the bet amount subtraction request message (S2007).

After S2007, the cash processing unit 220 of the deposit amount managing device 10 transmits to the financial institution system 70 information indicating the amount of money (bet amount) (the information is hereinafter also referred to as account transfer requesting message) (S2008).

After receiving the account transfer requesting message (S2009), the financial institution system 70 transfers to the bookmaker bank account the amount of money (bet amount) indicated by the account transfer requesting message (S2010).

After information indicative of the actual game result is received from a result information transmitter, the sportsbook operation managing center 460 shifts the process to S2011. In the present embodiment, the information indicating the actual game result means information indicating the result of a game actually played. For example, when the bet target is a game of A team versus B team, information indicative of the score (score at the end of the game and the score at the halftime) of each team and the number of shoots is transmitted from the result information transmitter to the sportsbook operation managing center 460 as the information indicative of the actual game result. Note that the result information transmitter is capable of transmitting information indicative of the actual game result to the sportsbook operation managing center 460. The information indicative of the game result corresponds to the result information of the aspects (6) to (7). When the sportsbook operation managing center 460 receives the information indicative of the game result, the predetermined server of the sportsbook operation managing center 460 serves as the result information receiving means of the aspect (6). The sportsbook operation managing center 460 determines whether or not the game result indicated by the five-digit number contained in the vote information matches with the actual game result (S2011). That is, there is determined whether or not the user has made a right guess in relation to the game serving as the bet target.

When it is determined that the game result indicated by the five-digit number matches with the actual game result, the sportsbook operation managing center 460 calculates an amount of money based on the information indicative of the bet amount which is contained in the vote information and the odds data (S2012). In short, the amount of money won by the user who made the right guess is calculated in this process. Next, the sportsbook operation managing center 460 transmits to the deposit amount managing device 10 information indicative of the deposit account (user deposit account) specified in S2004 and the amount of money (amount of money won) calculated in S2012 (the information is hereinafter also referred to as prize money addition request message) (S2013). Note that the information indicative of the amount of money won corresponds to the prize money information of the aspect (6). When the sportsbook operation managing center 460 executes S2013, the predetermined server of the sportsbook operation managing center 460 serves as the prize money information transmitting means of the aspect (6).

After the prize money addition request message is received from the sportsbook operation managing center 460 (S2014), the deposit amount managing unit 230 of the deposit amount managing device 10 adds the deposit amount corresponding to the amount of money won indicated by the prize money addition request message, to the amount in the deposit account (user deposit account) indicated by the prize money addition request message (S2015). The amount in the deposit account indicated by the prize money addition request message corresponds to the deposit amount of the user in the aspect (6). When the deposit amount managing unit 230 of the deposit amount managing device 10 executes S2015, the deposit amount managing unit 230 serves as the deposit amount managing means of the aspect (6).

After S2015, the cash processing unit 220 of the deposit amount managing device 10 transmits information (account transfer requesting message) indicative of the amount of money (amount of money won) to the financial institution system 70 (S2016).

After the account transfer requesting message is received (S2017), the financial institution system 70 withdraws an amount of money (bet amount) indicated by the account transfer requesting message from the bookmaker bank account (S2018).

Thus, an exemplary operation of the service providing system 6 of the present embodiment is described with reference to FIG. 16A and FIG. 16B.

The second embodiment deals with a case where the sportsbook is run based on the information indicated by the actual game result. However, the service providing system of the aspects (6) to (7) is not limited to this example. In other words, the service providing system 6 of the aspects (6) to (7) may be structured so that the game result is determined by a random number obtained by a server of the service providing system 6 (e.g., operation managing server 640).

The second embodiment deals with a case where the information indicating the game result (result information) is transmitted from the result information transmitter to the sportsbook operation managing center 460. However, the service providing system of the aspects (6) to (7) may be structured as follows. Namely, the information indicating the game result (result information) may be transmitted from the input device of the server (e.g., operation managing server 640) to the CPU of that server.

The second embodiment deals with a case where the information indicating the five-digit number (selection information) is transmitted from the user terminal device 20 by means of SMS. However, the service providing system of the aspects (6) to (7) is not limited to this. That is, the service providing system of the aspects (6) to (7) may transmit the selection information through the internet. An example where the selection information is transmitted through the internet will be described in a third embodiment.

The second embodiment deals with a case where the financial institution system 70 executes the money transferring process (S2010 of FIG. 16A and S2018 of FIG. 16B). That is, the embodiment deals with a case where the amount of the bookmaker bank account is increased with a decrease in the amount of the user deposit account. However, the service providing system of the aspects (6) to (7) is not limited to this. That is, the service providing system of the aspects (6) to (7) may be such that the financial institution system 70 does not execute the money transferring process. For example, a deposit account of the sportsbook operation managing center 460 (hereinafter also referred to as bookmaker deposit account) may be increased, with a decrease in the amount of the user deposit account. The third embodiment deals with an example where the amount of the bookmaker deposit account is increased with a decrease in the amount of the user deposit account.

### Third Embodiment

The third embodiment deals with the aspect (7). In the following description, the structuring elements that are identical to those of the service providing system described in the above embodiment are given the same reference symbols. Further, descriptions are omitted for those parts of the third embodiment which are as described in the above embodiment.

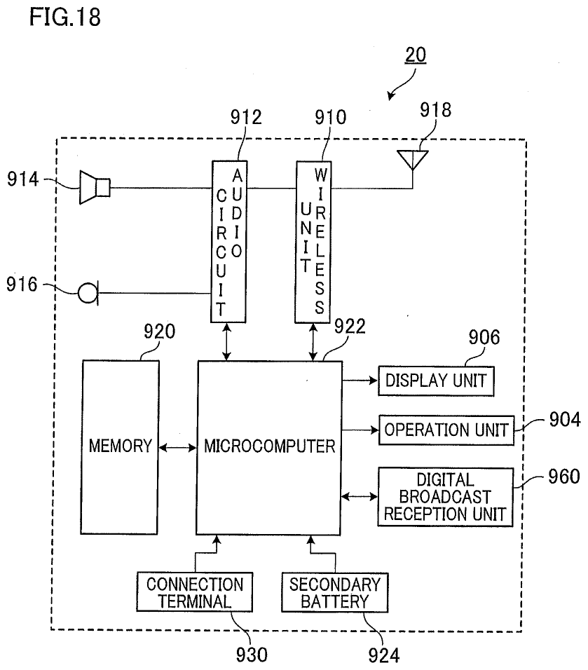

The following describes with reference to FIG. 18 an internal structure of a user terminal device related to the present embodiment. FIG. 18 is a block diagram showing the internal structure of the user terminal device related to the third embodiment.

The user terminal device 20 has a digital broadcast reception unit 960. The digital broadcast reception unit 960 receives terrestrial digital television broadcasting for portable phones and mobile terminals (e.g., One-segment broadcasting). The terrestrial digital television broadcasting received is viewed with a BML (Broadcast Markup Language) browser program stored in the memory 920. As should be understood, the user terminal device 20 of the third embodiment has a function that allows viewing of terrestrial digital television broadcasting. Note that the terrestrial digital television broadcasting corresponds to the digital broadcast of the aspect (7). The digital broadcast reception unit 960 corresponds to the digital broadcast receiving means of the aspect (7).

Thus, the internal structure of the user terminal device related to the present embodiment is described with reference to FIG. 18.

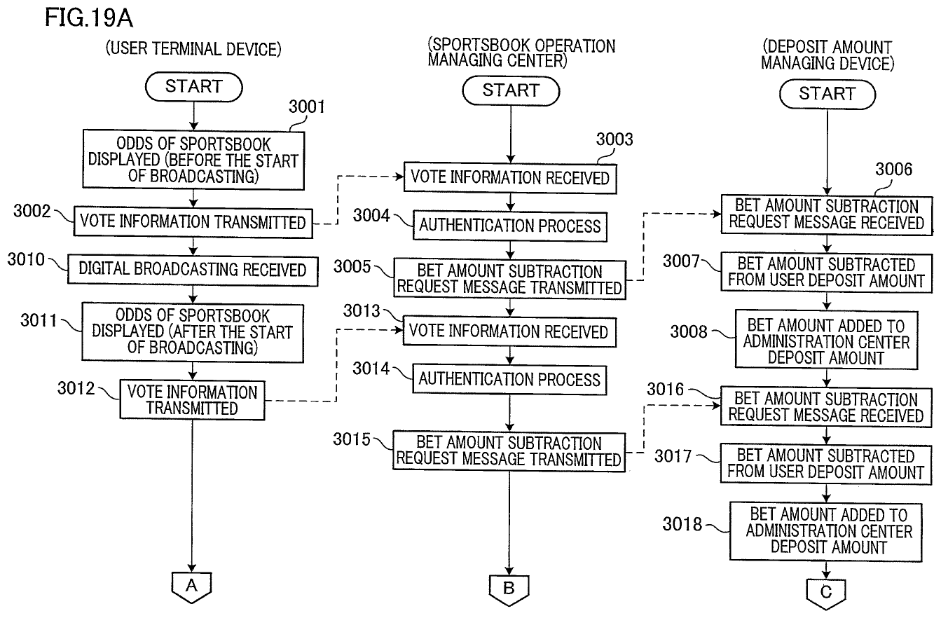

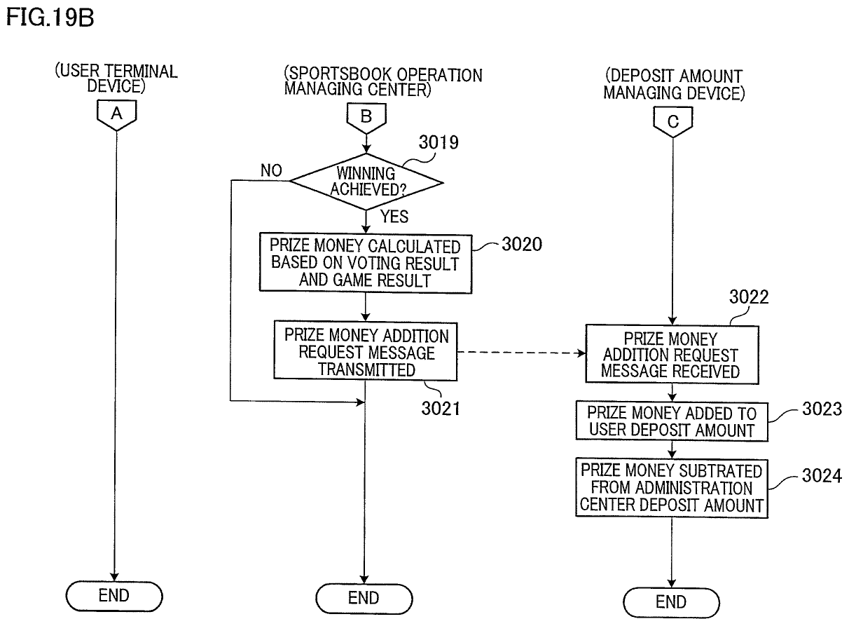

Next, the following describes an exemplary operation of the service providing system 6 related to the present embodiment with reference to FIG. 19A and FIG. 19B. FIG. 19A and FIG. 19B are sequence diagrams showing the exemplary operation of the service providing system 6 related to the third embodiment. Note that S3003 to S3005, and S3013 to S3015 of FIG. 19A and S3019 to S3021 of FIG. 19B are processes executed by a predetermined server of the sportsbook operation managing center 460.

First, the user terminal device 20 executes 53001 to 53002. These processes however are the same as S2001 to S2002 described with reference to FIG. 16A. Therefore, no further description is provided for these steps.

When the BML browser of the user terminal device 20 is activated after 53002, the user terminal device 20 receives a broadcasting wave (S3010). A television program distributed by the broadcasting wave becomes viewable by the BML browser provided to the user terminal device 20.

When a predetermined channel is selected, the user terminal device 20 receives a television program distributed by the digital terrestrial television broadcasting managing center 450 (S3011).

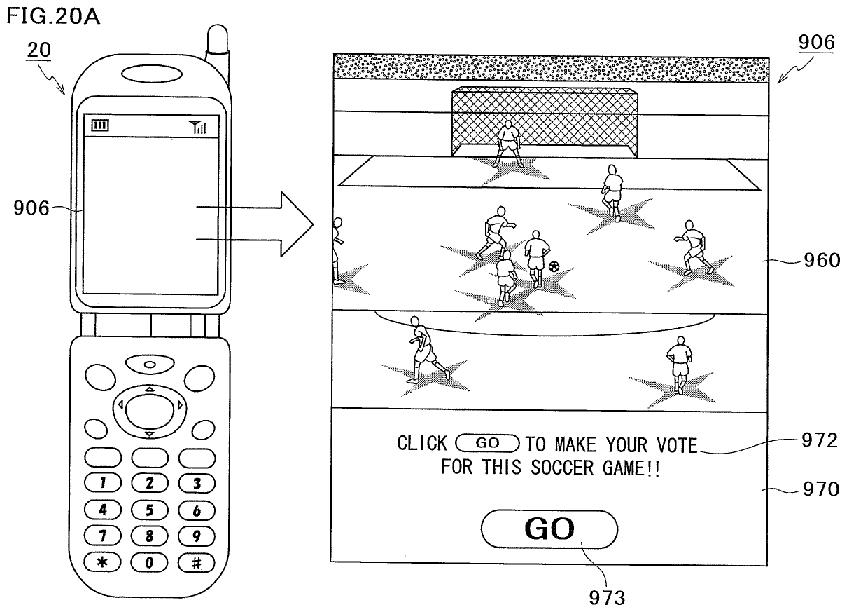

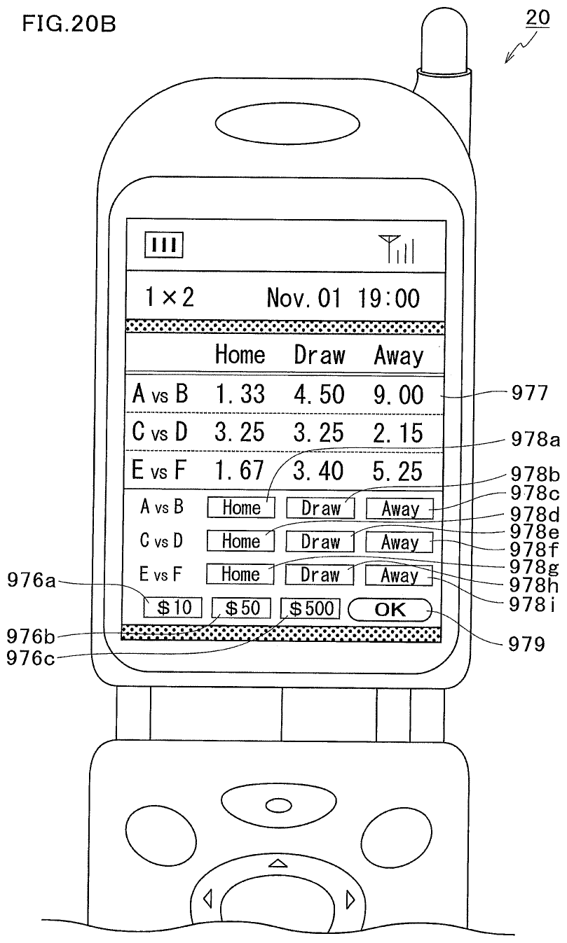

The following describes an example of television program (hereinafter also referred to as sportsbook television program) distributed by the digital terrestrial television broadcasting managing center 450 related to the present embodiment, with reference to FIG. 20A. As shown in FIG. 20A, when the user terminal device 20 receives a broadcasting wave, the display unit 906 displays a sportsbook television program image. The display unit 906 has a game image display area 960 and a link image display area 970. In the game image display area 960 of the present embodiment, an image of a soccer game is displayed. Further, the link image display area 970 displays a text string 972, and a GO-button image 973 linked to a web site that allows voting for the soccer game (hereinafter also referred to as bookmaker site). When the GO-button image 973 is selected, the web browser program stored in the memory 920 is activated, and connection to the contents managing server 630 is established. When the connection to the contents managing server 630 is established, the display unit 906 displays a web page (see FIG. 20B) of the bookmaker site.

The following describes the web page of the bookmaker site with reference to FIG. 20B. FIG. 20B shows an exemplary web page of the bookmaker site related to the present embodiment. As shown in an odds display image 975 of FIG. 20B, for each of the possible game results in relation to the game serving as the bet target, an odds image 977 is displayed. Further, the web page of the bookmaker site displays bet amount input button images 976a to 976c, result selection button images 978a to 978i, and an O.K.-button image 979. Each of the result selection button images 978a to 978i and the O.K.-button image 979 is linked to a web page. The player is able to select any of the result selection button images 978a to 978i by operating the control panel 904. The game result indicated by the result selection button image 978 selected by the player is the result prediction of the player in the sportsbook. By operating the control panel 904, the player is able to select any of bet amount button images 976a to 976c. The player may enter his/her bet amount in the sportsbook with the amount of money indicated by the bet amount button images 976. Note that the control panel 904 corresponds to the selection means in the aspect (7).

The present embodiment deals with a case where information indicative of the password set for each user and the phone number assigned to the user terminal device 20 on the transmitting end are transmitted to the sportsbook operation managing center 460 in addition to the information indicative of the result prediction and the bet amount (S3012). The password and the phone number are input by operating the control panel 904 and are transmitted to the sportsbook operation managing center 460 thereafter. Note that the vote information in the present embodiment means information indicative of the result prediction, the bet amount, the password, and the phone number assigned to the user terminal device 20 on the transmitting end. When the user terminal device 20 executes S3012, the micro computer 922 serves as the selection information transmitting means of the aspect (7).

Note that in the present embodiment, the odds varies with the progress of the soccer game. That is, the odds of 45 minutes after the start of soccer game may be different from the odds of 10 minutes after the start of the soccer game. In the present embodiment, the variable value of the odds is determined as follows. An odds managing server 620 provided to the sportsbook operation managing center 460 stores data (odds variable table data) indicating a table in which a variable value of the odds and a difference in the scores of the both teams are associated with each other. The operation managing center determines the variable value of the odds based on the odds variable table data and the difference in the scores of the actually played game. For example, where the odds before the start of the game is 1.5 and where the variable value is determined as to be +0.5, the odds will be 2.0. Note that the odds calculated based on the variable value is recognized by the user when the bookmaker site is updated (see FIG. 20B).

After receiving the vote information (S3003), the sportsbook operation managing center 460 executes S3004 to S3005. However, these processes are the same as S2004 to S2005 described with reference to FIG. 16A. Therefore, no further description of these processes are provided below.

After the bet amount subtraction request message is received from the sportsbook operation managing center 460 (S3006), the deposit amount managing unit 230 provided to the deposit amount managing device 10 subtracts the bet amount indicated by the bet amount subtraction request message, from the amount of the deposit account (user deposit account) which is indicated by the bet amount subtraction request message (S3007).

After S3007, the deposit amount managing unit 230 provided to the deposit amount managing device 10 adds the bet amount indicated by the bet amount subtraction request message, to the amount of the bookmaker deposit account (S3008).

After the vote information is received (S3013), the sportsbook operation managing center 460 executes S3014 to S3015. However, these processes are the same as S2004 to S2005 described with reference to FIG. 16A. Therefore, no further description of these processes is provided below.

After the bet amount subtraction request message is received from the sportsbook operation managing center 460 (S3016), the deposit amount managing unit 230 provided to the deposit amount managing device 10 subtracts the bet amount indicated by the bet amount subtraction request message, from the amount of the deposit account (user deposit account) indicated by the bet amount subtraction request message (S3017).

After S3017, the deposit amount managing unit 230 provided to the deposit amount managing device 10 adds the bet amount indicated by the bet amount subtraction request message, to the amount of the bookmaker deposit account (S3018).

When the information indicating the actual game result is received from the result information transmitter, the sportsbook operation managing center 460 shifts the process to S3019. The sportsbook operation managing center 460 then executes S3019 to S3021. However, these processes are the same as S2011 to S2013 described with reference to FIG. 16A. Therefore, no further description of these processes are provided below.

After the prize money addition request message is received from the sportsbook operation managing center 460 (S3022), the deposit amount managing unit 230 provided to the deposit amount managing device 10 adds the bet amount indicated by the prize money addition request message, to the amount of deposit account (user deposit account) indicated by the prize money addition request message (S3023).

After S3023, the deposit amount managing unit 230 provided to the deposit amount managing device 10 subtracts the bet amount indicated by the prize money addition request message, from the amount of the bookmaker deposit account (S3024).

Thus, an exemplary operation of the service providing system 6 related to the present embodiment is described with reference to FIG. 19A and FIG. 19B.

The second and third embodiments deal with a case where the bet amount subtraction request message is transmitted from the sportsbook operation managing center 460 to the deposit amount managing device 10. However, the service providing system of the aspects (6) to (7) is not limited to such an example. That is, the service providing system of the aspects (6) to (7) may be structured so that the bet amount subtraction request message is transmitted from the user terminal device 20 to the deposit amount managing device 10. The fourth embodiment deals with a case where the bet amount subtraction request message is transmitted from the user terminal device 20 to the deposit amount managing device 10.

The second and third embodiments deal with a case where the deposit amount managing device 10 adds the amount of money won to the deposit amount, after the prize money addition request message is received from the sportsbook operation managing center 460 (see S2015 of FIG. 16B and S3023 of FIG. 19B). However, the service providing system of the aspects (6) to (7) is not limited to this. That is, the service providing system of the aspects (6) to (7) may be structured so that a value corresponding to the amount of money won is added to the charge value stored in the user terminal device 20, after the prize money addition request message is received from the sportsbook operation managing center 460. The fourth embodiment deals with a case where a value corresponding to the amount of money won is added to the charge value stored in the user terminal device 20.

### Fourth Embodiment

The fourth embodiment deals with the aspect (8) of the present invention. In the following description, the structuring elements that are identical to those of the service providing system described in the above embodiment are given the same reference symbols. Further, descriptions are omitted for those parts of the fourth embodiment which are as described in the above embodiment.

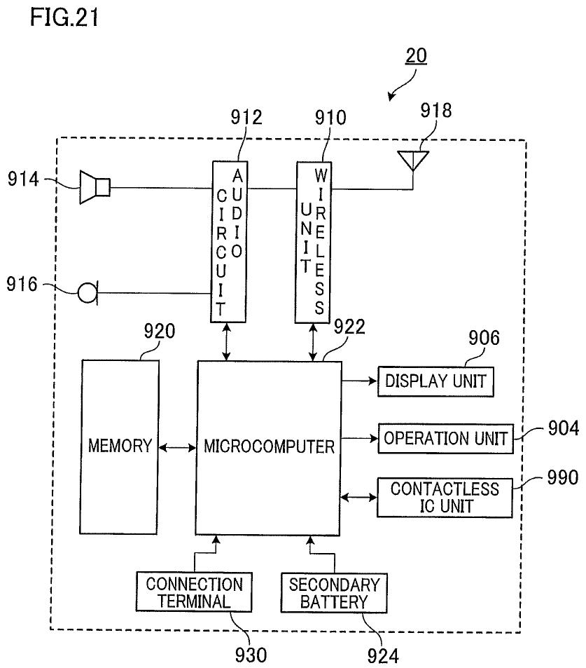

The following describes an internal structure of the user terminal device related to the present embodiment, with reference to FIG. 21. FIG. 21 is a block diagram of the internal structure of the user terminal device related to the present embodiment.

The user terminal device 20 includes a contactless IC unit 990. The contactless IC unit 990 is capable of performing contactless communication with a reader/writer. Further, the contactless IC unit 990 has a storage. The storage is capable of storing the later described charge value or the like. Examples of contactless IC unit includes Felica IC chip, Mifare IC Chip, or the like. Note that the storage provided to the contactless IC unit 990 corresponds to the terminal storage means of the aspect (8).

Thus, the internal structure of the user terminal device related to the present embodiment is described with reference to FIG. 21.

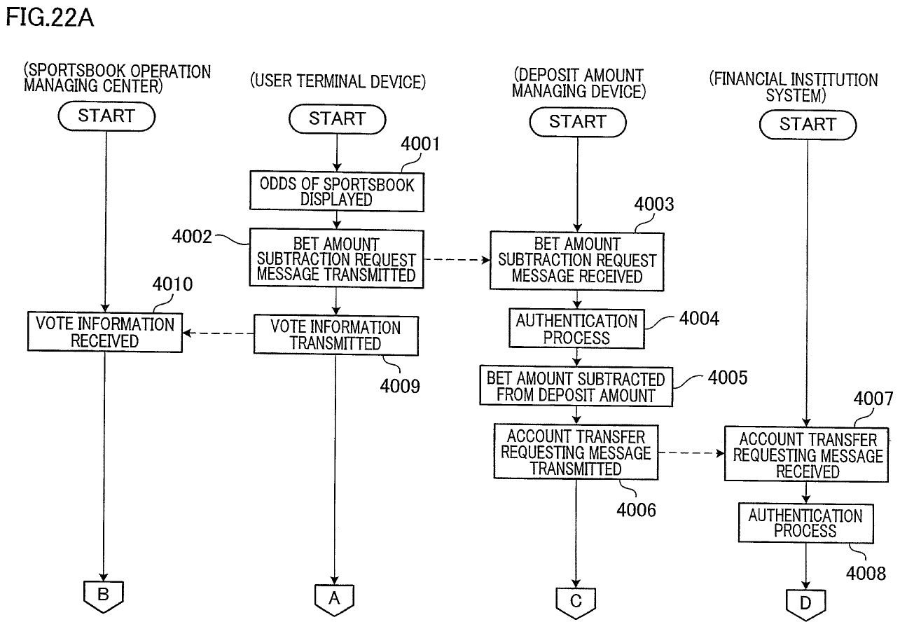

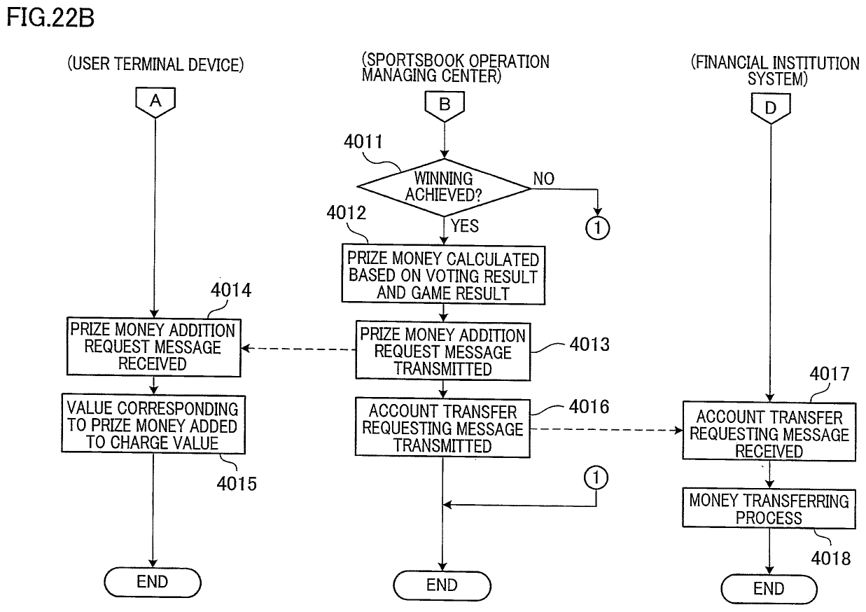

Next, the following describes an exemplary operation of the service providing system 6 related to the present embodiment, with reference to FIG. 22A and FIG. 22B. FIG. 22A and FIG. 22B are sequence diagram showing the exemplary operation of the deposit amount managing system related to the present embodiment. Note that S4010 of FIG. 22A, and S4011 to S4013 and S4016 of FIG. 22B are processes executed by a predetermined server of the sportsbook operation managing center 460.

In the present embodiment, an odds notification mail is transmitted from the sportsbook operation managing center 460 to the user terminal device 20. In the odds notification mail is displayed an URL (Uniform Resource Locator) of a web site (hereinafter, bookmaker site) that enables voting for a soccer game. When the URL is selected a web browser program stored in the memory 920 is activated and connection to the contents managing server 630 is established. When the connection to the contents managing server 630 is established, the display unit 906 of the user terminal device 20 displays a web page (see FIG. 20B) of the bookmaker site.

The user terminal device 20 displays the odds in the sportsbook by displaying the web page of the bookmaker site (S4001). After displaying the web page of the bookmaker site, the user terminal device 20 waits for a vote input for the sportsbook. At this time, the user is able to input a bet amount, a result prediction, the phone number assigned to the user terminal device 20, and a password set in advance for the user through a window image (not shown) displayed on the web page of the bookmaker site by operating the control panel 904.

Further, the process of S4001 may be as follows. Namely, when a bet amount and a result prediction are input, the display unit 906 of the user terminal device 20 displays a web page of the deposit amount managing device 10 (not shown). In the user terminal device 20 is installed an application program that establishes connection to the URL of the web page. When the bet amount and the result prediction are input, the user terminal device 20 establishes a connection to the URL of the web page based on the application program. In the web page, the user is able to input the phone number assigned to the user terminal device 20 and the password set in advance for the user. Note that the deposit amount managing device stores the web page in various languages (e.g., English, Spanish). The above application program may be an application program which establishes connection to the URL of the web page in the language (e.g., Spanish) corresponding to the identification information (e.g., phone number) of the user terminal device.

The user terminal device 20 transmits information indicative of the amount of money (bet amount), the phone number assigned to the user terminal device 20, and the password set in advance for the user (the information is hereinafter also referred to as bet amount subtraction request message) to the deposit amount managing device 10 (S4002).

After the bet amount subtraction request message is received from the user terminal device 20 (S4003), the deposit amount managing unit 230 of the deposit amount managing device 10 specifies the user based on the phone number of the user terminal device 20 which is indicated by the bet amount subtraction request message, the password, and the client registration data (data in which the portable phone number, the password, and the deposit account are associated for each member), and then specifies the user deposit account (S4004). When the phone number and the password indicated by the bet amount subtraction request message do not match with the information indicated by the client registration data and specifying the user therefore is not possible, the deposit amount managing unit 230 of the deposit amount managing device 10 transmits to the user terminal device 20 data containing a text string noting that the user is not able to participate in the sportsbook.

After S4004, the deposit amount managing unit 230 of the deposit amount managing device 10 subtracts the bet amount indicated by the bet amount subtraction request message, from the amount of the deposit account specified in S4004 (S4005).

After S4005, the cash processing unit 220 of the deposit amount managing device 10 transmits to the financial institution system 70 information indicative of the amount of money (bet amount) (hereinafter, also referred to as account transfer requesting message) (S4006).

After the account transfer requesting message is received (S4007), the financial institution system 70 transfers the amount of money (bet amount) indicated by the account transfer requesting message to the bookmaker bank account (S4008).

After S4002, the user terminal device 20 transmits to the deposit amount managing device 10 vote information indicative of the amount of money (bet amount), the result prediction, the phone number assigned to the user terminal device 20, and the password set in advance for the user (S4009).

The sportsbook operation managing center 460 receives the vote information from the user terminal device 20 (S4010).

When the information indicative of the actual game result is received from the result information transmitter, the sportsbook operation managing center 460 shifts the process to S4011. The sportsbook operation managing center 460 determines whether or not the result prediction indicated by the vote information matches with the actual game result (S4011). That is, there is determined whether or not the user has made a right guess in relation to the game serving as the bet target. When it is determined that the result prediction indicated by the vote information matches with the actual game result, the sportsbook operation managing center 460 calculates an amount of money (amount of money won) based on the bet amount indicated by the vote information and the odds data (S4012). That is, this process determines the amount of money the user has won by making a right guess. Next, the sportsbook operation managing center 460 transmits information indicative of the amount of money (amount of money won) calculated in S4012 (prize money addition request message) to the user terminal device 20 having transmitted the vote information with the result prediction which is determined as to match with the actual game result in S4011 (S4013).

After the prize money addition request message is received from the sportsbook operation managing center 460 (S4014), the user terminal device 20 adds, to the charge value stored in the storage of the contactless IC unit 990, a value corresponding to the amount of money won which is indicated by the prize money addition request message (S4015).

After S4013, the sportsbook operation managing center 460 transmits to the financial institution system 70 information indicative of the amount of money (amount of money won) calculated in S4012 (account transfer requesting message) (S4016).

After the account transfer requesting message is received (S4017), the financial institution system 70 withdraws the amount of money (amount of money won) indicated by the account transfer requesting message, from the bookmaker bank account (S4018).

Note that the S4001 to S4004 of FIG. 22A may be as follows. Namely, the odds notification mail may display, in relation to the game to be the bet target (e.g., a game A vs. B), an URL for each of the possible game results (e.g., A's win, Draw, B's win). The player may transmit the information indicative of the result prediction to the sportsbook operation managing center 460, by selecting the URL. When the selection of URL is entered, the web browser program stored in the memory 920 is activated to establish connection to the server of the deposit amount managing center 300. When the connection to the server of the deposit amount managing center 300 is established, the web page (not shown) stored in the server is displayed on the display unit 906 of the user terminal device 20. After the web page is displayed, the user terminal device 20 waits for an input of the deposit account number and the password. At this time, the user is able to input the deposit account number and the password through the window image (not shown) displayed on the web page, by operating the control panel 904. The user terminal device 20 transmits, to the deposit amount managing device 10, information indicative of the deposit account number and the password. When the information is received from the user terminal device 20, the deposit amount managing unit 230 of the deposit amount managing device 10 specifies the user deposit account, based on the deposit account number indicated by the information and the client registration data (data in which the deposit account and the password are associated for each member). When the amount of the user deposit account is more than the bet amount and when the password indicated by the information is the password corresponding to the specified user deposit account, the deposit amount managing unit 230 shifts the process to S4005. On the other hand, when the amount of the specified user deposit account is determined as to be less than the bet amount or when the password indicated by the information is not the password corresponding to the specified user deposit account, the deposit amount managing unit 230 transmits to the user terminal device 20 a mail that participation of the user in the sportsbook is not permitted. Note that in this case, the client registration data is stored in the server of the deposit amount managing device 10.

Thus, an exemplary operation of the service providing system 6 related to the present embodiment is described with reference to FIG. 22A and FIG. 22B.

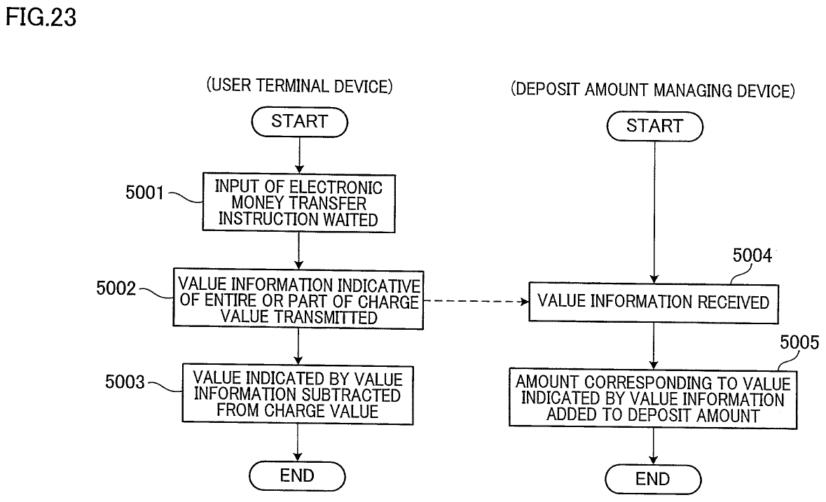

Next, the following describes an exemplary operation of the deposit amount managing system related to the present embodiment, with reference to FIG. 23. FIG. 23 is a sequence diagram showing an exemplary operation of the deposit amount managing system related to the present embodiment.

The user terminal device 20 waits for an input of an electronic money shift instruction (S5001). When the micro computer 922 of the user terminal device 20 receives a signal from the control panel 904, a web browser program stored in the memory 920 is activated and connection to the deposit amount managing server 305 of the deposit amount managing center 300 is established. When the connection to the deposit amount managing server 305 is established, the display unit 906 displays a web page (not shown) set by the deposit amount managing center 300. In S5001, the micro computer 922 of the user terminal device 20 receives information indicative of a value and information specifying the deposit account from the control panel 904. At this time, the user is able to input a charge value he/she wish to shift to the deposit amount managing device 10 through the window image (not shown) displayed on the display unit, by operating the control panel 904. Further, the user is able to input a deposit account number for specifying the deposit account through the window image (not shown) displayed on the display unit 906, by operating the control panel 904. In the present embodiment, the information for specifying the deposit account is referred to as deposit account information. Note that the information indicative of the value corresponds to the value information of the aspect (8).

After S5001, the user terminal device 20 transmits the value information received in S5001 and the deposit account information to the deposit amount managing device 10 (S5002). When the user terminal device 20 executes S5002, the micro computer 922 serves as the value information transmitting means of the aspect (8).

After S5002, the user terminal device 20 subtracts the value indicated by the value information having been transmitted in S5002, from the charge value stored in the storage of the contactless IC unit 990 (S5003). When the user terminal device 20 executes the process of S5004, the micro computer 922 serves as the charge value subtraction means of the aspect (8).

After the value information and the deposit account information are received from the user terminal device 20 (S5004), the deposit amount managing device 10 adds an amount corresponding to the value indicated by the value information, to the deposit amount of deposit account indicated by the deposit account information (S5005). When the deposit amount managing device 10 executes a process of S5004, the communication control unit 210 of the deposit amount managing device 10 serves as the value information reception means of the aspect (8). When the deposit amount managing device 10 executes the process of S5005, the deposit amount managing unit 230 of the deposit amount managing device 10 serves as the deposit amount increasing means of the aspect (8).

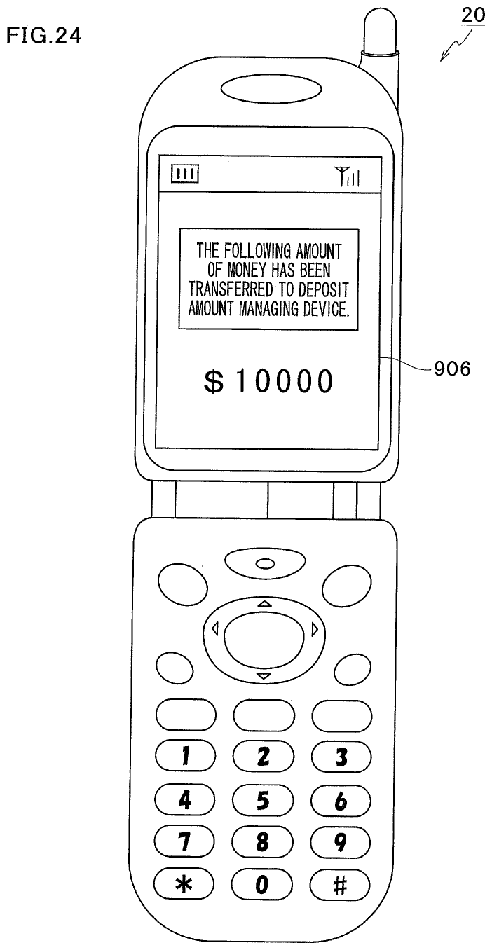

After S5003, the user terminal device 20 displays on the display unit 906 a shifting-completion reporting image (see FIG. 24).

Thus, an exemplary operation of the deposit amount managing system related to the present embodiment is described with reference to FIG. 23.

The fourth embodiment deals with a case where the charge value is stored in the contactless IC unit 990. However, the charge value of the aspect (8) is not limited to this example. Namely, the charge value of the aspect (8) may be stored in the memory 920.

The above embodiment deals with a case where the bet amount is subtracted from the deposit amount after the deposit amount managing device 10 receives the bet amount subtraction request message (see S2007 of FIG. 16A, S3007 of FIG. 19, S3017 of FIG. 19, and S4005 of FIG. 22A). However, in the present invention, the timing of subtracting the bet amount is not limited to this example. Namely, the subtraction of the bet amount and addition of the amount of money won may be executed at a single timing, after the prize money addition request message is received.

The embodiment deals with a case where a predetermined server of the sportsbook operation managing center 460 or the deposit amount managing device 10 executes the authentication process (S2004 of FIG. 16A, S3004 of FIG. 19A, S4004 of FIG. 22A), after the bet amount and the result prediction are input by the user (after a vote in the sportsbook is entered). However, the present invention may be such that the authentication process is executed by the bookmaker managing server or the deposit amount managing device, before the bet target is selected (e.g., before the voting in the sportsbook). This shortens the time taken from the point of starting the vote to the point of completing the vote by the user. Adoption of such a structure is particularly preferable in cases where the sportsbook provided by the service providing system of the present invention is such that the odds vary with elapse of time. When the vote information is transmitted before the authentication process, the bookmaker managing server or the deposit amount managing device may transmit an authentication incompletion signal to the portable terminal, and an invalidation image may be displayed on the display unit of the portable terminal.

When the sportsbook provided by the service providing system of the present invention such that the odds vary with elapse of time, the following structure may be adoptable for example. The bookmaker managing server has a timer capable of measuring time elapsed from the start of a game. Further, the bookmaker managing server receives game progress information indicative of the progress of the game (e.g., scoring by one of the teams) which is input by an external input device (e.g., keyboard). Further, the bookmaker managing server has a memory storing a program for varying the odds based on the time elapsed and the progress of the game. By reading out and running the program, the bookmaker managing server varies the odds based on the time elapsed and the progress of the game. Further, the program may be a program for varying odds according to the voting conditions, in which case the bookmaker managing server varies the odds based on the program, every time the selection information indicative of the bet target selected on the portable terminal is received.

The above described embodiments (first embodiment to fourth embodiment) deal with a case where the currency type (USD, EUR, RMB) is set for each of the separate storages 281 to 283. Further, the second embodiment to fourth embodiment deal with a case where US dollar is used for voting at the sportsbook. The present invention is applicable when the currency type of the deposit amount stored in the storage means and the currency type of the bet amount are the same (when the currency types of the deposit amounts include the currency type of the bet amount). However, the present invention is also applicable to cases where the currency types of the deposit amounts do not include the currency type of the bet amount. For example, it is possible to use, for voting, Boliviano (the currency of Bolivia) which is different from the currency type (USD, EUR, RMB) set to the separate storages 281 to 283. Note that the present invention may be such that the individual user deposit amount storage unit has only a storage for which a single currency is set.

As described, when the currency type of the deposit amount and that of the bet amount are different, the following structure may be adopted. The service providing system of the aspect (6) or (7), wherein

the deposit amount managing device includes currency determining means for determining whether or not currency types of the deposit amounts include the currency type of a bet amount, and money exchange means for converting the currency type of the bet amount into one of the currency types of the deposit amounts, based on the exchange rate indicating the relation between the currency type of the bet amount and each of the currency types of the deposit amounts, when the currency determining means determines that the currencies of the deposit amounts do not include the currency of the bet amount, wherein

the deposit amount managing means subtracts, from the deposit amount stored in the storage means, the bet amount having been converted into the one of the currency types of the deposit amounts by the money exchange means. The data indicating the exchange rate may be stored in the exchange rate storage means of the deposit amount managing device, or obtained from an external device (money exchanging server).

The currency type of the bet amount may be set in advance or be the currency type (e.g., Boliviano) of the region where the portable terminal is (e.g., Bolivia). For example, the following structure may be adopted. The service providing system of the aspect (6) or (7), adapted so that: the portable terminal includes

GPS signal receiving means for receiving GPS signals from a GPS satellite,

position calculation means for calculating a position on the earth, based on the GPS signal received from the GPS signal receiving means,

bet amount determining means for determining the bet amount based on the currency type corresponding to the position calculated by the position calculation means. In the service providing system, the portable terminal or the deposit amount managing device stores a currency specifying table indicating the relation between the position on the earth and the corresponding currency type, and specifies the currency type based on the position calculated by the position calculation means and the currency specifying table. The deposit amount managing device specifies the currency type as follows. Namely, the portable terminal transmits to the deposit amount managing device position information indicative of the position calculated by the position calculation means. The deposit amount managing device receives the position information and specifies the currency type. Note that the currency specifying table may be structured by a table associating a position on the earth (a combination of the latitude longitude) and an area of the earth (e.g., country, city or municipality structuring a country, or the like), and a table associating the area on the earth with a currency type.

The GPS signal receiving means is capable of receiving a GPS signal from a GPS satellite. The GPS stands for Global Positioning System and is a system for determining the position by a satellite. The GPS satellite is a satellite used for determining a position in the GPS. The GPS signal is a signal transmitted from the GPS satellite for determining the position. In the GPS, a position is usually calculated by using GPS signals from at least four GPS satellites, based on the distance from each of the GPS satellites. The position calculated is expressed in a combination of the latitude and the longitude.

Further, the present invention may adopt the following structure. The service providing system of the aspect (6) or (7), wherein:

the deposit amount managing device includes currency determining means for determining whether currency types of the deposit amounts include a currency type of the bet amount, money exchange means for converting any of the currency types of the deposit amounts stored in the storage means into the currency type of the bet amount, based on the exchange rate indicating the relation between the currency type of the bet amount and each of the currency types of the deposit amounts, when the currency determining means determines that the currency types of the deposit amounts do not include the currency type of the bet amount, and converted deposit amount information transmitting means for transmitting to the portable terminal converted deposit amount information indicative of the deposit amount having been converted into the currency of the bet amount by the money exchange means. When the converted deposit amount information is received from the converted deposit amount information transmitting means, the portable terminal displays the converted deposit amount on the display unit. As the result, the user is able to grasp the bet amount he/she can use for voting. As in the above described embodiment, when the individual user deposit amount storage unit has separate storages whose set currency types are different from one another, the portable terminal displays the converted deposit amount for each separate storage, on the display unit. This assist the user in determining how much bet amount to use for voting, from each of the separate storages. Further, in this case, the portable terminal may be structured so that the total of the bet amounts in each separate storages is displayed on the display unit. The total of the bet amounts may be calculated in the portable terminal, or may be calculated in the deposit amount managing device and transmitted to the portable terminal.

Further, in the present invention, the following structure may be adopted. The service providing system of the aspect (6) or (7),

the deposit amount managing device includes program storage means for storing a program which distributes the bet amount to each of the separate storages; and

the deposit amount managing means subtracts a bet amount (individual bet amount) distributed based on the program, from the deposit amount stored in each of the separate storages. For example, when the largest deposit amount (e.g., $120) among the deposit amounts stored in the separate storages equals or surpasses a bet amount (e.g., $100), the bet amount (e.g., $100) is distributed as the individual bet amount to the separate storage storing the largest deposit amount. When the largest deposit amount (e.g., $80) among the deposit amounts stored in the separate storages is less than the bet amount (e.g., $100), an amount corresponding to this deposit amount (e.g., $80) is distributed as the individual bet amount to that separate storage storing the largest deposit amount, and the difference between the deposit amount and the bet amount (e.g., $20) is distributed to another separate storage. For example, the difference (e.g., $20) is distributed as the individual bet amount to a separate storage storing the largest deposit amount among the rest of the separate storages. The total of the individual bet amounts equals to the bet amount. The program may be a program for calculating a plurality of patterns of distributing the bet amount to the separate storages. The plurality of distribution patterns are displayed on the portable terminal. This way, the plurality of distribution patterns are shown to the user. In this case, it is preferable that the user is able to select any of the plurality of distribution patterns.

Note that the present invention may be structured so as to enable the user to determine any given amount as the bet amount, or enable the user to select through the control panel of the portable terminal the amount of a predetermined minimum bet amount times N (where N is a natural number).

### REFERENCE NUMERALS

1 . . . deposit amount managing system; 6 . . . service providing system
10 . . . deposit amount managing device
20 . . . user terminal device; 30 . . . communication network; 40 . . . store terminal device
50 . . . automatic teller machine 60 . . . money exchanging server 70 . . . financial institution system
220 . . . cash processing unit; 230 . . . deposit amount managing unit
240 . . . money exchange processing unit; 270 . . . deposit amount storage unit
300 . . . deposit amount managing center
450 . . . digital terrestrial television broadcasting managing center
460 . . . sportsbook operation managing center; 906 . . . display unit
960 . . . digital broadcast reception unit 960; 990 . . . contactless IC unit

What is claimed is:

1. A bookmaker management server for sending odds information to a user terminal device, comprising:
a memory which is configured to store odds variation table data in which a variation in odds on a possible game result of a game is associated with game progress information indicating the progress of the game; and
a controller which is programmed to execute the processes of:
(A) receiving the game progress information which is input at an external input device;
(B) calculating the odds corresponding to the game progress information, based on the game progress information received in the process (A) and the odds variation table data; and
(C) sending the odds calculated in the process (B) to the user termination device, as the odds information.

2. The bookmaker management server according to claim 1, further comprising
a timer which is configured to measure elapsed time from start of the game,
the memory storing odds variation table data in which the game progress information is associated with the elapsed time, and
in the process (B), the controller executing a process of calculating the odds corresponding to the game progress information and the elapsed time, based on the game progress information received in the process (A), the elapsed time measured by the timer, and the odds variation table data.

3. A terminal device for receiving odds information from a bookmaker management server, the terminal device comprising a display,
the terminal device receiving odds as the odds information from the bookmaker management server, the odds being calculated based on:
(i) data which is for varying the odds and associated with a variation in the odds on a possible game result of a game and game progress information indicating the progress of the game and
(ii) the game progress information, and
the terminal device displaying the odds information on the display.

4. A recording medium storing a program which causes a terminal device to receive odds information from a bookmaker management server,
the program causing the terminal device to execute the processes of:
receiving odds as the odds information from the bookmaker management server, the odds being calculated based on (i) data which is for varying the odds and associated with a variation in the odds on a possible game result of a game and game progress information indicating the progress of the game and (ii) the game progress information; and
displaying the odds information on a display of the terminal device.
